(19) United States
(12) Patent Application Publication
(10) Pub. No.: US 2026/0200213 A1
(43) Pub. Date: Jul. 16, 2026

(54) ADHESIVE-FREE ENGINEERED PLANT MATERIALS, AND METHODS FOR FABRICATION THEREOF

(71) Applicant: UNIVERSITY OF MARYLAND, COLLEGE PARK, College Park, MD (US)

(72) Inventors: Liangbing HU, Woodbridge, CT (US); Yu LIU, Berwyn Heights, MD (US); Taotao MENG, College Park, MD (US); Yue GAO, Berwyn Heights, MD (US)

(21) Appl. No.: 19/138,280

(22) PCT Filed: Dec. 13, 2023
(86) PCT No.: PCT/US23/83783

§ 371 Date: Jun. 12, 2025

Related U.S. Application Data
(60) Provisional application No. 63/387,162, filed on Dec. 13, 2022.

(51) Int. Cl. B32B 23/18; B32B 23/04; C08H 8/00

(52) U.S. Cl. CPC B32B 23/18; B32B 23/04; C08H 8/00

(57) ABSTRACT

An engineered structure can be formed from multiple plant material pieces joined together without the use of an additional adhesive. In some examples, instead of an adhesive, a filler can be provided to enhance the surface chemistry of the constituent plant-material pieces, for example, by providing increased points for formation of hydrogen bonds, as well as providing a bridging effect by filling gaps within and/or between the constituent plant-material pieces. Alternatively, in some examples, lignin within the constituent plant-material pieces can be used as a bonding agent to couple together adjacent pieces. At least some of the pieces forming the engineered structure can be densified, lignin-compromised plant materials.

### CROSS-REFERENCE TO RELATED APPLICATIONS

The present application claims the benefit of U.S. Provisional Application No. 63/387,162, filed Dec. 13, 2022, entitled “Super Strong Oriented Strand Board (OSB) and Methods Thereof,” which is hereby incorporated by reference herein in its entirety.

### STATEMENT REGARDING FEDERALLY SPONSORED RESEARCH

This invention was made with Government support under DEAR0001025 awarded by the Department of Energy, Advanced Research Projects Agency-Energy (DOE ARPA-E). The Government has certain rights in this invention.

### FIELD

The present disclosure relates generally to engineered structures, and more particularly, to strength-enhanced laminated or layered structures formed from multiple pieces of plant materials (e.g., wood, bamboo, etc.).

### BACKGROUND

Adhesives have typically been used to fabricate engineered structures with larger dimensions than the constituent bamboo or wood materials, such as plywood, particle board, oriented strand board (OSB), glued laminated timber (glulam), cross-laminated timber (CLT), and laminated veneer lumber (LVL). While synthetic adhesives, such as phenolic and urea-formaldehyde resin, can provide good bonding strength, such adhesives are derived from non-renewable fossil resources and require energy-intensive and complex manufacturing processes, which can contribute to global warming. Moreover, the use of synthetic adhesives can emit carcinogenic formaldehyde gas, which can be harmful to animal health.

Bio-based adhesives derived from natural materials have been developed, which may be cost-effective and more eco-friendly as compared to conventional adhesives. For example, extracted lignin has been used as a bio-based adhesive in composite materials. However, such extracted lignin offers poor adhesive performance when applied directly to the constituent wood or bamboo pieces due to weak chemical crosslinking.

Embodiments of the disclosed subject matter may address one or more of the above-noted problems and disadvantages, among other things.

### SUMMARY

Embodiments of the disclosed subject matter system provide engineered structure formed from multiple plant material pieces joined together without the use of an additional adhesive (e.g., adhesive-free). In some embodiments, instead of an adhesive, a filler is provided to enhance the surface chemistry of the constituent plant-material pieces, for example, by providing increased points for formation of hydrogen bonds, as well as providing a bridging effect by filling gaps within and/or between the constituent plant-material pieces. Alternatively or additionally, in some embodiments, lignin within the constituent plant-material pieces (e.g., in situ modified lignin) can be used as a bonding agent to couple together adjacent pieces, for example, by bonding between the lignin and cellulose microfibrils. In some embodiments, at least some of the pieces forming the engineered structure can be lignin-compromised plant materials, for example, partially-delignified and/or containing modified lignin. In some embodiments, at least some of the pieces forming the engineered structure have been densified. The use of fillers and/or lignin as a bonding agent can enable engineered structures with enhanced mechanical properties (e.g., tensile strength) and/or environmental characteristics (e.g., recyclability, biodegradability).

In one or more embodiments, an engineered structure can comprise a plurality of pieces of plant material and a filler or bonding agent. The pieces of plant material can be arranged to form at least two layers. At least some of the pieces can be lignin-compromised plant material. The filler or bonding agent can couple together adjacent pieces of the plant material so as to form a unitary layered structure. The filler can comprise a polysaccharide, or the bonding agent can comprise lignin.

In one or more embodiments, a method can comprise providing a plurality of pieces of plant material. At least some of the pieces can be lignin-compromised plant material. The method can further comprise arranging the plurality of pieces of plant material in at least two layers. The method can also comprise compressing the at least two layers so as to form a unitary layered structure.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of modification and/or removal of lignin from a natural plant material, according to one or more embodiments of the disclosed subject matter.

FIGS. 1B-1E are simplified schematic diagrams illustrating aspects of fabrication of unitary layered structures using a filler and multiple lignin-compromised plant material pieces, according to one or more embodiments of the disclosed subject matter.

FIG. 1F shows images of unitary layered structures fabricated from lignin-compromised wood pieces, from lignin-compromised hemp pieces, and lignin-compromised bamboo pieces, according to one or more embodiments of the disclosed subject matter.

FIG. 1G shows an image of a unitary layered structure that has a thickness greater than 2.5 cm, fabricated from lignin-compromised wood, according to one or more embodiments of the disclosed subject matter.

FIG. 1H shows an image of a unitary layered structure that has a nonplanar shape, fabricated from lignin-compromised wood, according to one or more embodiments of the disclosed subject matter.

FIG. 2A is a simplified schematic diagram illustrating aspects of forming a unitary layered structure using lignin as a bonding agent to couple together adjacent plant material pieces, according to one or more embodiments of the disclosed subject matter.

FIG. 2B is a simplified schematic diagram illustrating aspects of the coupling via lignin, according to one or more embodiments of the disclosed subject matter.

FIGS. 2C-2F are simplified schematic diagrams illustrating aspects of fabrication of unitary layered structures using lignin and multiple lignin-compromised plant material pieces, according to one or more embodiments of the disclosed subject matter.

FIG. 2G shows an image of a unitary layered structure fabricated from lignin-compromised bamboo pieces, according to one or more embodiments of the disclosed subject matter.

FIG. 2H shows an image of a unitary layered structure that has a length of 100 cm, fabricated from lignin-compromised bamboo, according to one or more embodiments of the disclosed subject matter.

FIG. 3A is a process flow diagram of a method for fabricating a unitary layered structure using a filler, according to one or more embodiments of the disclosed subject matter.

FIG. 3B is a process flow diagram of a method for fabricating a unitary layered structure using lignin as a bonding agent, according to one or more embodiments of the disclosed subject matter.

FIG. 4A shows images from fabrication of an oriented strand board (OSB), formed using lignin-modified wood and carboxymethyl cellulose (CMC) as a filler, according to one or more embodiments of the disclosed subject matter.

FIG. 4B shows images of surfaces of a the fabricated OSB of FIG. 4A.

FIG. 4C shows an image of another fabricated OSB, formed using lignin-modified wood and CMC as a filler, according to one or more embodiments of the disclosed subject matter.

FIG. 5A shows a stress-strain curve for a fabricated OSB, formed using lignin-modified wood and CMC as filler without drying prior to densification.

FIG. 5B is a graph of measured tensile strength of fabricated OSB, formed using lignin-modified wood and CMC as filler without drying prior to densification, as a function of thickness of the starting wood pieces.

FIG. 5C is a graph of flexure stress versus displacement for a fabricated OSB, formed using lignin-modified wood and CMC as filler without drying prior to densification.

FIG. 5D is a graph of compressive stress versus displacement for a fabricated OSB, formed using lignin-modified wood and CMC as filler without drying prior to densification.

FIG. 6A compares measured Brinell hardness values for an OSB formed using natural wood and CMC and OSB formed using lignin-modified wood and CMC as filler without drying prior to densification.

FIG. 6B shows stress-strain curves for fabricated OSB, formed using dried, previously-densified, lignin-modified wood and CMC as filler.

FIG. 6C shows a stress-strain curve for fabricated OSB, formed using dried, previously-densified, lignin-modified wood and epoxy as adhesive.

FIGS. 7A-7C are side-view scanning electron microscopy (SEM) images of natural bamboo, softened bamboo (lignin-compromised bamboo), and in situ glubam (a unitary layered structure formed by co-densification of adjacent pieces of softened bamboo), respectively.

FIGS. 7D-7F are magnified SEM images of a single fiber in natural bamboo, a single fiber in softened bamboo, a bonding fiber in the in situ glubam, respectively.

FIGS. 7G-7I are confocal fluorescent images of lignin in natural bamboo, lignin in the softened bamboo, and lignin in the in situ glubam, respectively.

FIGS. 8A-8C are cross-sectional SEM images of natural bamboo, softened bamboo, and in situ glubam, respectively.

FIGS. 8D-8F are magnified cross-sectional SEM images of fibers in natural bamboo, fibers in softened bamboo, and fibers in the in situ glubam, respectively.

FIGS. 9A-9C are polarized light microscopy images of fibers in natural bamboo, fibers in softened bamboo, and fibers in the in situ glubam, respectively.

FIGS. 10A-10C are two-dimensional (2D) heteronuclear single quantum correlation (HSQC) nuclear magnetic resonance (NMR) spectra of whole cell walls from natural bamboo, softened bamboo, and in situ glubam, respectively.

FIGS. 11A-11C are 2D HSQC NMR spectra of lignin aliphatic regions (δC/δH 50-90/2.4-6.0) of natural bamboo, softened bamboo, and in situ glubam, respectively.

FIGS. 11D-11F are 2D HSQC NMR spectra of lignin aromatic regions (δC/δH 90-150/5.8-8.3) of natural bamboo, softened bamboo, and in situ glubam, respectively.

FIGS. 11G-11H illustrate lignin aliphatic structures and lignin aromatic structures, respectively.

FIG. 12A shows NMR quantification of lignin aliphatic structures in natural bamboo, softened bamboo, and in situ glubam, respectively.

FIG. 12B shows small-angle X-ray scattering (SAXS) spectra patterns of natural bamboo, softened bamboo, and in situ glubam, respectively.

FIG. 13A show tensile strengths of in situ glubam fabricated using different hot-pressing temperatures.

FIG. 13B shows shear strengths of in situ glubam fabricated using bamboo pieces with different lignin contents.

FIG. 13C compares shear strengths for a laminate fabricated from natural bamboo and in situ glubam.

FIG. 13D shows images of natural bamboo laminate and in situ glubam samples after tensile testing.

FIGS. 13E-13F shows confocal fluorescent images of natural bamboo laminate and in situ glubam samples, respectively.

FIGS. 14A-14B are cross-sectional SEM images of natural bamboo laminate and in situ glubam samples, respectively.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Plant Material: A portion (e.g., a cut portion, via mechanical means or otherwise) of any photosynthetic eukaryote of the kingdom Plantae in its native state as grown. In some embodiments, the plant material comprises wood (e.g., hardwood or softwood), bamboo (e.g., any of Bambusoideae, such as but not limited to Moso, Phyllostachys vivax, Phyllostachys viridis, Phyllostachys bambusoides, Phyllostachys nigra, Guadua angustifolia, Bambusa emeiensis, Arundinaria gigantea, Chusquea culeou, and Bambusa vulgaris Vittata), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), hemp (Cannabis sativa), or grass (e.g., a species selected from the Poales order or the Poaceae family). For example, the natural wood can be any type of hardwood (e.g., having a native lignin content in a range of 18-25 wt %) or softwood (e.g., having a native lignin content in a range of 25-35 wt %), such as, but not limited to, basswood, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew. Alternatively, in some embodiments, the plant material can be any type of fibrous plant composed of lignin and cellulose. For example, the plant material can be bagasse (e.g., formed from processed remains of sugarcane or sorghum stalks) or straw (e.g., formed from processed remains of cereal plants, such as rice, wheat, millet, or maize). Alternatively, in some embodiments, the plant material can be a waste product, such as wood waste (e.g., pulp) or agricultural waste.

Engineered Structure or Engineered Material: A structure formed from a plurality of pieces or layers of natural or modified plant materials coupled together without an additional adhesive to form a structure with improved strength and/or durability. In some embodiments, the plant material pieces are coupled together via either a filler (e.g., a polysaccharide) or via lignin acting as a bonding agent. Examples of such structures/materials include, but are not limited to, laminated timber or bamboo (e.g., glubam), oriented strand board (OSB), oriented structural straw board (OSSB), and parallel strand lumber (PSL).

Lignin-compromised plant material: Plant material that has been modified by one or more chemical treatments to (a) modify the native lignin therein and/or (b) partially remove the native lignin therein (i.e., partial delignification). In some embodiments, the lignin-compromised plant material can substantially retain the native microstructure of the natural plant material formed by cellulose-based cell walls.

Partial Delignification: The removal of some (e.g., at least 5%) but not all (e.g., less than or equal 95%) of native lignin (e.g., on a weight percent basis) from the naturally-occurring plant material. In some embodiments, the partial delignification can be performed by subjecting the natural plant material to one or more chemical treatments. In some embodiments, the lignin content after partial delignification can be in a range of 0.9-23.8 wt % for hardwood or bamboo, or in a range of 1.25-33.25 wt % for softwood. Lignin content within the plant material before and after the partial delignification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” and U.S. Publication No. 2022/0412002, published Dec. 29, 2022 and entitled “Bamboo Structures, and Methods for Fabrication and Use Thereof,” which delignification and densification processes are incorporated herein by reference.

Lignin modification: In situ altering one or more properties of native lignin in the naturally-occurring plant material, while retaining at least some (e.g., most) of the altered lignin within the plant material. In some embodiments, the lignin content of the plant material prior to and after the in situ modification can be substantially the same, for example, such that the in situ modified plant material retains at least 90% (e.g., removing no more than 10%, or no more than 1%, of the native lignin content) of the native lignin content. In some embodiments, the plant material can be in situ modified (e.g., by chemical reaction with OH) to depolymerize lignin, with the depolymerized lignin being retained within the plant material microstructure. In some embodiments, the modified lignin has shorter macromolecular chains than that of native lignin in the pieces of natural plant material, and/or the modified lignin has more exposed functional groups on its surface as compared to native lignin of corresponding natural plant material. The lignin content within the plant material before and after lignin modification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), ASTM E1758-01(2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in International Publication No. WO 2023/028356, published Mar. 2, 2023, and entitled “Waste-free Processing for Lignin Modification of Fibrous Plant Materials, and Lignin-modified Fibrous Plant Materials,” which lignin modification processes are incorporated herein by reference.

Densified Plant Material: A plant material that has been compressed to have a reduced thickness. In some embodiments, the thickness has been reduced by a factor of at least two. In some embodiments, the densified plant material can have a density greater than that of the native plant material, for example, at least 1 g/cm³, such as at least 1.1 g/cm³ or even at least 1.2 g/cm³ (e.g., 1.3-1.5 g/cm³). For example, the densified plant material can be formed as described in, but not limited to, U.S. Pat. No. 11,130,256, issued Sep. 28, 2021, entitled “Strong and Tough Structural Wood Materials, and Methods for Fabricating and Use Thereof,” and International Publication No. WO 2021/108576, published Jun. 3, 2021, entitled “Bamboo Structures, and Methods for Fabrication and Use Thereof,” each of which is incorporated herein by reference.

Fiber direction: A direction along which a plant grows from its roots or from a trunk thereof, with cellulose fibers forming cell walls of the plant being generally aligned with the fiber direction. In some cases, the fiber direction may be generally vertical or correspond to a direction of its water transpiration stream. This is in contrast to the radial direction, which extends from a center portion of the plant outward.

### Introduction

Disclosed herein are engineered structures formed from plant material pieces. In some embodiments, the engineered structure is a unitary layered structure with adjacent pieces therein coupled together without using an additional adhesive. In some embodiments, instead of a separate adhesive, a filler is provided between adjacent pieces to enhance the surface chemistry of the constituent plant material pieces, for example, by providing an increased number of points for formation of hydrogen bonds. Alternatively or additionally, in some embodiments, lignin from the constituent plant material pieces, can be used as a bonding agent to couple together adjacent pieces, for example, by bonding between the lignin and cellulose microfibrils.

In some embodiments, one, some, or all of the constituent pieces of the engineered structure can be formed of lignin-compromised plant materials. In some embodiments, one or more of the plant material pieces can be partially delignified, for example, having a lignin content less than that of the starting (e.g., native) plant material. Alternatively or additionally, in some embodiments, one or more of the plant material pieces can have modified lignin therein, for example, having shorter macromolecular chains than that of native lignin and/or having more exposed functional groups on its surface as compared to the native lignin. In some embodiments, the modified lignin can be used as a bonding agent to couple together the adjacent pieces.

In some embodiments, one, some, or all of the constituent pieces of the engineered structure can be densified, for example, prior to coupling together the constituent pieces or as part of the coupling together. For example, the densified piece of plant material and/or the overall engineered structure can have a density of at least 1 g/cm³ (e.g., ≥1.1 g/cm³ or ≥1.2 g/cm³, for example, in a range of 1.3-1.5 g/cm³, while a density of the plant material in its native stage can be less than 1 g/cm³ (e.g., ≤0.5 g/cm³, such as about 0.45 g/cm³ ).

In some embodiments, the engineered structure can have enhanced mechanical strength, for example, as compared to existing engineered materials (e.g., formed with native or non-densified wood with conventional adhesives). For example, the engineered structure can exhibit a tensile strength of at least 100 MPa (e.g., ≥200 MPa, such as in a range of 200-300 MPa, inclusive), a bonding strength of at least 4 MPa, a shear strength of at least 3 MPa, or any combination of the foregoing.

Compared to the costly and complex processes involved in conventional laminated structures that use additional adhesive, embodiments of the disclosed subject matter can provide engineered structures via a facile and eco-friendly process with fewer steps. Embodiments of the disclosed subject matter can also be more cost-effective and eco-friendly than conventional structural materials formed from metals and polymer composites. For example, the disclosed engineered structures can be biodegradable and/or more readily recyclable (e.g., by reprocessing into other products at the end of their lifecycle). The disclosed engineered structures can be applied in numerous applications where enhanced strength is desired such as, but not limited to, structural materials (e.g., building construction, vehicle components, etc.) or industrial projects (e.g., wind turbine blades, etc.).

### Layered Structures Employing Fillers

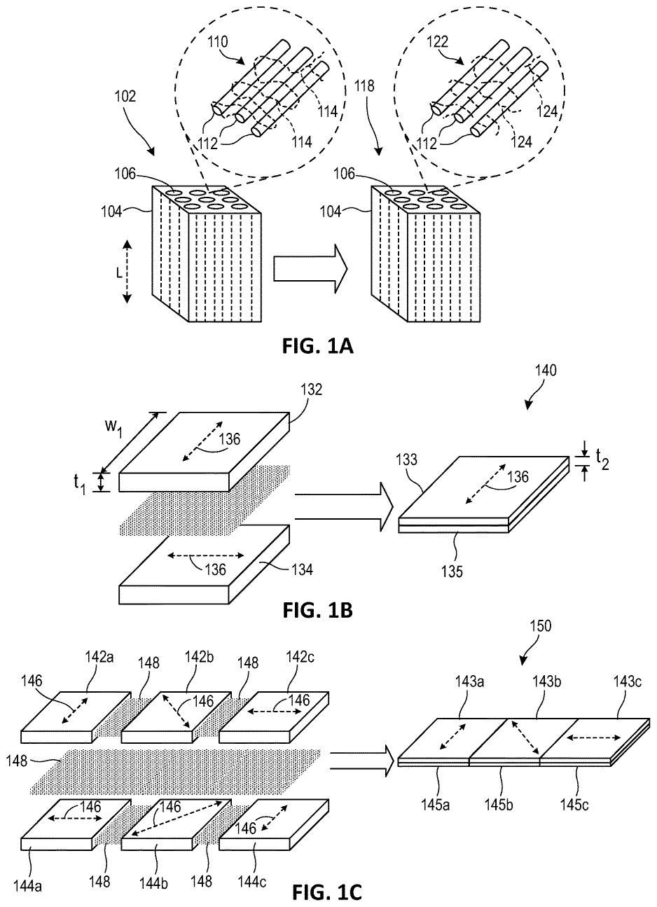

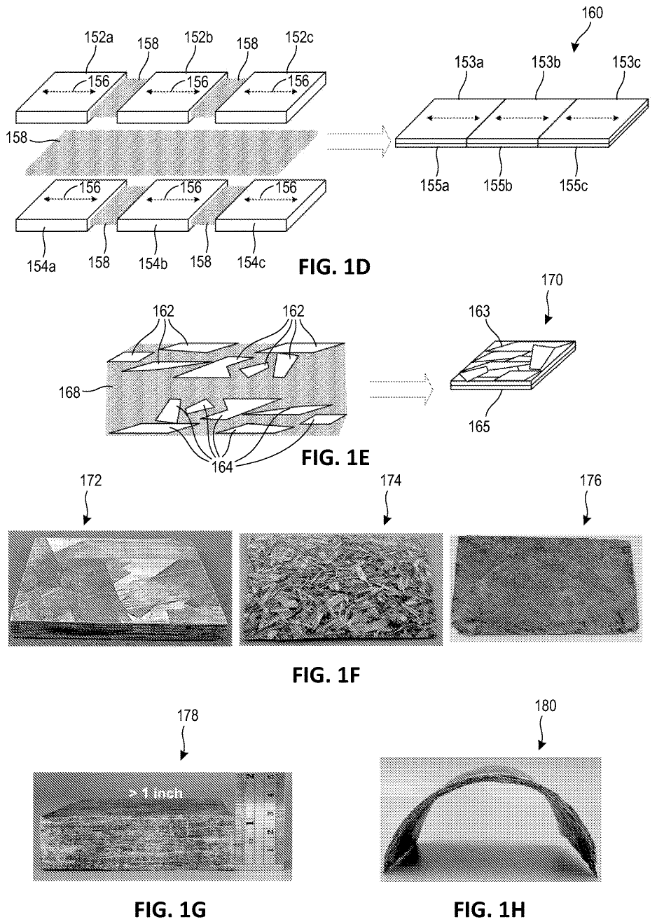

In some embodiments, an engineered structure can be a unitary layered structure formed of multiple pieces of plant material coupled together via a filler. The layered structure can include at least two layers. In some embodiments, one, some, or all of the layers can comprise multiple plant material pieces therein. At least some of the pieces can be formed of lignin-compromised plant material. In some embodiments, the lignin-compromised plant material can comprise in situ modified lignin. For example, in its native state 102 as shown in FIG. 1A, a plant material 104 can be infiltrated or infused with one or more chemicals, for example, via the native lumina formed by cellulose-based fibers 106 in the microstructure of the plant material. For example, the microstructure can have longitudinally-extending fiber cell walls formed of a composite 110 of cellulose nanofibrils 112 bonded together by a hemicellulose and lignin adhesive matrix 114, which is strong and rigid. In some embodiments, the infiltrated chemicals can comprise a chemical that produces hydroxide (OH⁻) ions in solution, for example, an alkaline chemical.

Upon activation (e.g., via heating at an elevated temperature, such as 80-180° C., for example, via a steam reactor), the infiltrated chemicals can modify the native lignin in situ. For example, in its lignin-modified state 118, the macromolecular chains of the native lignin can be broken into smaller segments 124, thereby resulting in a more compliant composite 122 for the plant material while still retaining the cellulose-based fibers 106 and lumina in the native microstructure. In particular, the hydroxide ions can react with the phenolic hydroxyl groups in lignin so as to break to down the linking bonds of lignin macromolecules, thereby shortening the lignin macromolecular chains and softening the plant material. In addition, the hydroxide can degrade hemicellulose by peeling reaction, which produces acidic degradation products that react with the infiltrated chemicals to form neutral salts. As a result of the lignin-modified composite 122, the softened plant material can be more easily densified (e.g., via pressing).

After densification, or when the plant material is otherwise subsequently dried after the chemical activation that produces the in situ lignin modification, the removal of water can immobilize the degradation products within the modified plant material. Moreover, since the chemicals are consumed in producing the in situ lignin modification, the resulting softened plant material can exhibit a neutral pH, while avoiding or at least reducing production of black liquor and other wastewater. In some embodiments, the in situ lignin modification can result in a reduction in lignin content of the processed plant material by no more than 10%. For example, a content of modified lignin (e.g., on a wt % basis) in the processed plant material (e.g., softened plant material and/or densified plant material) can be at least 90% (e.g., at least 95%) of a content of the native lignin originally in the natural plant material. For example, after the in situ modification, the processed plant material can have a lignin content greater than or equal to 25 wt % for softwood, greater than or equal to 20 wt % for hardwood, or greater than or equal to 26 wt % for bamboo. Alternatively or additionally, in some embodiments, the in situ modification can result in a reduction in hemicellulose content of the processed plant material by no more than 10%. For example, a content of modified hemicellulose (e.g., on a wt % basis) in the processed plant material (e.g., softened plant material and/or densified plant material) can be at least 90% (e.g., at least 95%) of a content of the native hemicellulose originally in the natural plant material.

Alternatively, in some embodiments, the lignin-compromised plant material can be partially delignified, for example, to reduce lignin content in the plant material to between 5% and 95%, inclusive, of a native lignin content of the plant material. In some embodiments, the partial delignification can be achieved by immersing the plant material (or a portion thereof) in one or more chemical solutions (e.g., alkaline solution) at an elevated temperature (e.g., about 70-160° C.). For example, after the partial delignification, the plant material can have a lignin content in a range of 1.25-33.25 wt % for softwood or in a range of 0.9-23.8 wt % for hardwood or bamboo. Alternatively or additionally, in some embodiments, the lignin content of the plant material after partial delignification can be at least 10 wt %. As a result of the partial delignification, the plant material is softer and thus can be more easily densified (e.g., via pressing).

Prior to or after arranging in layers, the plant material pieces can be pressed together (e.g., densified). In some embodiments, the pressing may be along a direction substantially perpendicular to a fiber direction (L) of the plant material. For example, during pressing, the lignin-compromised plant material can be compressed to form a densified material, with the previously-open cellulose-based lumina now substantially collapsed. Alternatively, in some embodiments, the pressing may be along a direction crossing the longitudinal growth direction or parallel to the longitudinal growth direction.

In some embodiments, the pressing is performed with the filler between adjacent plant material pieces and with the plant material pieces in a wet state (e.g., from a lignin compromising treatment without an intervening drying step). For example, the plant material pieces can have a moisture content of at least 15 wt % (e.g., about 20 wt %). Because the plant material pieces are in a wet state, conventional adhesives (e.g., urea-formaldehyde, phenol formaldehyde, etc.) cannot be used to join the pieces due to their incompatibility with water and/or their curing requirements. In contrast, the use of a filler can allow the plant material pieces to be coupled together in the wet state, for example, during the pressing for densification. In some embodiments, the filler can also enhance coupling between the plant material pieces, for example, by filling gaps within and/or between plant material pieces, as well as providing more points for hydrogen bonding.

In some embodiments, the filler can comprise a polysaccharide that has a plurality of polar functional groups that originate from an organic acid. For example, the filler can comprise derivatives or synthesize large molecule polysaccharides that are rich in polar (e.g., organic acid) groups, such as carboxyl and hydroxyl groups. In some embodiments, the polysaccharide can comprise starch, chitin, chitosan, cellulose, carboxymethyl cellulose (CMC), methyl cellulose, ethyl hydroxyethyl cellulose, hydroxyethyl cellulose, and/or hydroxypropyl methylcellulose. Alternatively or additionally, the filler can comprise sodium alginate, xanthan gum, guar gum, carrageenan, and/or gum arabic. The use of such fillers can result in an engineered structure with improved mechanical properties (e.g., increased tensile strength, stiffness, and/or shear strength) and/or allow the use of less filler to achieve desired performance. For example, the content of filler in the final unitary layered structure can be less than or equal to 5 wt % (e.g., in a range of 1-5 wt %).

For example, CMC can be used as the filler to improve the surface of wet processed plant materials by increasing the amount of carboxymethyl group and hydroxyl groups, which provides a larger amount of bonding points for hydrogen bonds. In addition, due to its relatively small size, the CMC molecules can fill gaps between adjacent wet processed plant materials, leading to stronger connections. The presence of water can enhance the effectiveness of CMC in this structure. In contrast, CMC may be less effective when used with previously densified plant material and/or dried plant material due to the lack of water.

In FIG. 1B, an engineered structure can be formed by layering lignin-compromised plant material pieces 132, 134 (e.g., in a wet state) with a filler 138 therebetween, and then pressing the layers together, for example, along a direction in which the layers are stacked. In the illustrated example, the pressing is also along a direction perpendicular to the respective fiber directions 136 of the plant material pieces 132, 134. The plant material pieces 132, 134 can be in the form of strands or chips, for example, having a cross-sectional size (e.g., in a plane perpendicular to a direction in which the layers are stacked) of 15-25 mm along one direction (e.g., W₁) and 75-150 mm along an orthogonal direction.

In some embodiments, the pressing can be effective to densify the lignin-compromised plant material pieces 132, 134, for example, forming densified pieces 133, 135 having a thickness t₂ less than their starting thickness t₁ (e.g., t₂≤0.5×t₁) and/or having a density of at least 1 g/cm³ . For example, the starting thickness t₁ of the pieces 132, 134 can be less than or equal to 0.5 mm (e.g., in a range of 0.1-0.4 mm). The pressing can also encourage bond formation (e.g., hydrogen bonds) between the filler and/or the densified plant material pieces 133, 135, thereby forming the unitary layered structure 140.

In the illustrated example of FIG. 1B, the fiber directions 136 are orthogonally arranged. However, other predetermined or random orientations for the fiber directions 136 are possible according to one or more contemplated embodiments, including crossing (nonparallel or forming an angle between 0 and 90°) or aligned (substantially parallel, e.g., parallel strand board). In addition, FIG. 1B shows only a single plant material piece in each layer. However, in some embodiments, one, some, or each layer in an engineered structure can be comprised of multiple plant material pieces, which may substantially identical or different in terms of material composition, size, and/or shape. Moreover, FIG. 1B shows engineered structure 140 with only two layers. However, any number of layers can be provided according to one or more contemplated embodiments.

For example, FIG. 1C shows another engineered structure 150 formed by layering (e.g., within a mold) lignin-compromised plant material pieces 142a-142c, 144a-144c (e.g., in a wet state) with a filler 148 between layers and between adjacent plant material pieces within a layer, and then pressing the layers together. As with the example of FIG. 1C, the pressing can be effective to densify the lignin-compromised plant material pieces 142a-142c, 144a-144c, thereby forming densified pieces 143a-143c, 145a-145c in respective layers coupled together via the filler and hydrogen bonding. In the illustrated example of FIG. 1C, the pieces are oriented such that fiber directions of adjacent pieces within a layer and between layers cross (e.g., orthogonal); however, other orientations are also possible. For example, FIG. 1D shows another engineered structure 160 formed by layering lignin-compromised plant material pieces 152a-152c, 154a-154c with fiber directions all substantially aligned. As with the example of FIG. 1D, the filler 158 can be disposed on and/or between adjacent plant material pieces, and the subsequent pressing can densify the constituent pieces to form densified pieces 153a-153c, 155a-155c coupled together via the filler and hydrogen bonding.

Although FIGS. 1C-1D show a linear array of similarly sized/shaped pieces in each layer, embodiments of the disclosed subject matter are not limited thereto. Rather, in some embodiments, plant material pieces of different shapes and/or sizes, arranged in two dimensions, can be combined together in a single layer, for example, as shown in FIG. 1E. In the illustrated example, multiple strands or chips 162, 164 are randomly arranged to form respective first and second layers, with a filler 168 disposed between and/or on the respective strands or chips. As with the above-described examples, the pressing can be effective to densify the strands or chips 162, 164, thereby forming densified pieces 163, 165 in respective layers coupled together via the filler and hydrogen bonding.

In some embodiments, a coating can be applied on one or more surfaces (e.g., external or exposed surfaces) of the unitary layered structure, for example, to protect against water or other environmental exposure. For example, in some embodiments, a waterproof or water-resistant coating can comprise polyurethane, varnish, lacquer, tung oil, and/or polymerized linseed oil.

Alternatively or additionally, in some embodiments, the coating on external surfaces can comprise an epoxy (e.g., marine epoxy, such as Marine Weld™ sold by the J-B Weld Company). In some embodiments, an additive can be applied within the unitary layer structure, for example, by adding to the filler or otherwise providing on the constituent plant material pieces (e.g., prior to densification). In some embodiments, the additive can act as a flame retardant. For example, the flame retardant additive can comprise antimony trioxide, magnesium hydroxide, aluminum hydroxide, borate, tributyl phosphate, tris(2-ethylhexyl) phosphate, tris(2-chloroethyl) phosphate, tricresyl phosphate, and/or triphenyl phosphate.

Engineered structures can be formed by combining a filler (e.g., CMC) with various plant material pieces, such as but not limited to wood (e.g., wood oriented strand board (OSB) 172 in FIG. 1F), hemp (e.g., hemp-OSB 174 in FIG. 1F), and bamboo (e.g., bamboo-OSB 176). Moreover, the thickness of the starting plant material pieces and/or the number of layers can be selected to achieve a desired thickness for the engineered structure, for example, greater than 2 cm, as shown by wood-OSB 178 in FIG. 1G. Although FIGS. 1B-1G illustrate substantially planar shapes (e.g., rectangular prism), embodiments of the disclosed subject matter are not limited thereto. Rather, in some embodiments, one or more molds can be used to form (e.g., during the pressing to densify the plant material pieces and/or couple the pieces together) the engineered structure to have a curved or three-dimensional shape (e.g., arc, wave, polygon, etc.), for example, an arcuate structure 180 as shown in FIG. 1H.

In any of the above noted examples, the constituent pieces within a layer of the unitary layered structure can be formed of a same plant material or different plant materials. Alternatively or additionally, in any of the above noted examples, one, some, or all of the constituent pieces of one layer can be formed of a same plant material or different plant materials from one, some, or all of the constituent pieces in another layer. Alternatively or additionally, in any of the above noted examples, the constituent pieces within a layer of the unitary layered structure can have a substantially similar shape (e.g., shaped as a strand or chip), a substantially similar size (e.g., a planar area and/or thickness within 20% of an average of pieces in the layer), and/or a substantially similar orientation (e.g., with fiber directions substantially parallel). Alternatively, in any of the above noted examples, the constituent pieces within a layer of the unitary layered structure can have different sizes, shapes, and/or orientations. Alternatively or additionally, in any of the above noted examples, one, some, or all of the constituent pieces of one layer can have a substantially similar shape, size, and/or orientation as one, some, or all of the constituent pieces in another layer. Alternatively, in any of the above noted examples, one, some, or all of the constituent pieces of one layer can have a different shape, size, and/or orientation as one, some, or all of the constituent pieces in another layer. In some embodiments, lignin-compromised plant material pieces can be combined with other plant material pieces (e.g., without lignin compromising or previously densified) and/or other structural materials (e.g., metal, non-densified wood, etc.).

For example, in some embodiments, pieces from different feedstocks (e.g., wood or branches thereof, bamboo or stalks thereof, grass, straw, wood waste, agricultural waste, etc.) can be mixed together within a layer or used in different layers in an engineered structure. In some embodiments, the orientations of pieces within each layer can be random, for example, to yield substantially isotropic properties. Alternatively, in some embodiments, the orientations of pieces within each layer can be substantially aligned, for example, to make a long board.

Alternatively or additionally, in some embodiments, the orientations of pieces within a layer and/or between layers can be such that their fiber directions cross (e.g., +45°/−45°direction), for example, to provide a structure that resists shear (e.g., a web of an I-beam or joist). In some embodiments, the size, shape, and/or type of pieces can be varied based on location within the final unitary structure, for example, with longer pieces arranged in top and/or bottom layers (e.g. to increase strength) and with shorter pieces arranged in middle layers (e.g., to increase packing density and/or reduce cost).

### Layered Structures Employing Lignin

In some embodiments, an engineered structure can be a unitary layered structure formed of multiple pieces of plant material coupled together using lignin from the plant materials as a bonding agent. The layered structure can include at least two layers. In some embodiments, one, some, or all of the layers can comprise multiple plant material pieces therein. At least some of the pieces can be formed of lignin-compromised plant material, for example, partially-delignified plant material and/or having modified lignin therein. For example, a lignin content in the lignin-compromised plant material can be 15-20 wt %. As a result of the lignin-compromising, the plant material is softer and thus can be more easily densified (e.g., via pressing).

Prior to or after arranging in layers, the plant material pieces can be pressed together (e.g., densified). In some embodiments, the pressing may be along a direction substantially perpendicular to a fiber direction of the plant material. For example, during pressing, the lignin-compromised plant material can be compressed to form a densified material, with the previously-open cellulose-based lumina now substantially collapsed. Alternatively, in some embodiments, the pressing may be along a direction crossing the longitudinal growth direction or parallel to the longitudinal growth direction. In some embodiments, the pressing is performed at an elevated temperature, for example, at about or greater than a glass transition temperature of lignin, such that at least some of the lignin remaining in the plant materials can extend between and couple together cellulose fibers within adjacent plant material pieces. The resulting engineered structure can exhibit enhanced mechanical properties, such as a bonding strength between an adjacent pair of layers of at least 4 MPa, a tensile strength of at least 200 MPa, and/or a shear strength of at least 3 MPa.

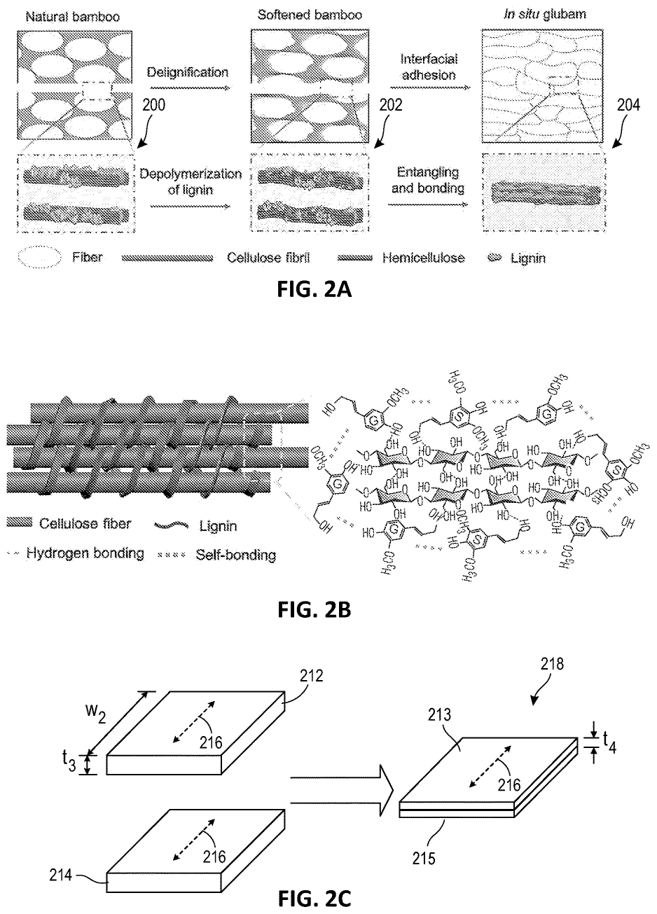

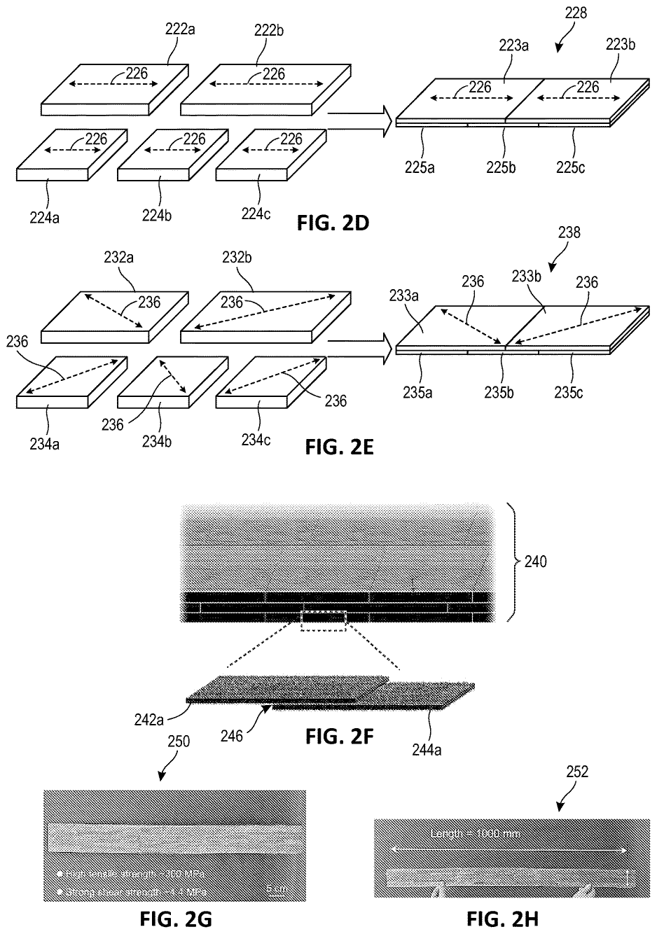

For example, FIG. 2A illustrates transformation of pieces of natural bamboo into an engineered structure (also referred to herein as in situ glubam) using lignin from the pieces as a bonding agent. In its native state, the bamboo microstructure 200 comprises a solid matrix of cellulose, hemicelluloses, and lignin. A partial delignification treatment (e.g., using an alkaline solution such as NaOH) can be applied to the bamboo pieces, which causes the lignin and hemicelluloses to be partially dissolved and removed (e.g., via washing) from the bamboo, thereby exposing and softening the cellulose fibrils in the lignin-compromised bamboo microstructure 202. This treatment can also generate wrinkles and pores in the bamboo structure and can expose more surface functional groups of the lignin and cellulose nanofibrils. The remaining lignin in the cell wall can thus be modified, for example, depolymerized into small molecular weight segments and/or having more exposed functional groups on its surface as compared to the native lignin. The softened bamboo can then be hot-pressed (e.g., at a temperature ≥120° C. and/or a pressure ≥10 MPa), which can collapse the bamboo fibers into a close-packed structure. The hot pressing can cause the remaining lignin to penetrate and embed into the voids of the cellulose fibers and spread on the fiber surface, as shown in the microstructure 204. The residual lignin can physically interact with the aligned cellulose nanofibrils via enhanced hydrogen bonding and physical adhesion, for example, as shown in FIG. 2B, which can yield a strong adhesive interface between the lignin and cellulose fibrils.

Despite the absence of any chemical adhesives, the reinforced filling and bonding effect of lignin with cellulose microfibril can create a powerful bridge network via intermolecular hydrogen bonding interaction. For example, the hydrogen bonding and physical entanglement in the lignin/cellulose complex can create a super strong adhesive interface, for example, having a 4.4±0.3 MPa bonding strength.

In FIG. 2C, an engineered structure can be formed by layering lignin-compromised plant material pieces 212, 214 without any separate adhesive thereon or therebetween, and then pressing the layers together, for example, along a direction in which the layers are stacked. In the illustrated example, the pressing is also along a direction perpendicular to the respective fiber directions 216 of the plant material pieces 212, 214. The plant material pieces 212, 214 can be in the form of strands, chips, or panels, for example, having a cross-sectional size (e.g., in a plane perpendicular to a direction in which the layers are stacked) of 10-30 mm along one direction (e.g., W₂) and 20-50 mm along an orthogonal direction.

In some embodiments, the pressing can be effective to densify the lignin-compromised plant material pieces 212, 214, for example, forming densified pieces 213, 215 having a thickness t₄ less than their starting thickness t₃ (e.g., t₄≤0.5×t₃) and/or having a density of at least 1 g/cm³ . For example, the starting thickness t₃ of the pieces 212, 214 can be less than or equal to 2 mm (e.g., in a range of 0.1-2 mm). The pressing can also encourage lignin to infiltrate between and bond to the densified plant material pieces 213, 215, thereby forming the unitary layered structure 218.

In the illustrated example of FIG. 1B, the fiber directions 216 are substantially aligned arranged. However, other predetermined or random orientations for the fiber directions 216 are possible according to one or more contemplated embodiments, including crossing (nonparallel or forming an angle between 0 and 90°) or orthogonal (forming an angle of about 90°). In addition, FIG. 2C shows only a single plant material piece in each layer. However, in some embodiments, one, some, or each layer in an engineered structure can be comprised of multiple plant material pieces, which may substantially identical or different in terms of material composition, size, and/or shape. Moreover, FIG. 2C shows engineered structure 218 with only two layers. However, any number of layers can be provided according to one or more contemplated embodiments.

For example, FIG. 2D shows another engineered structure 228 formed by layering (e.g., within a mold) lignin-compromised plant material pieces 222a-222b, 224a-224c without a separate adhesive, and then pressing the layers together. As with the example of FIG. 2C, the pressing can be effective to densify the lignin-compromised plant material pieces 222a-222b, 224a-224c, thereby forming densified pieces 223a-223b, 225a-225c in respective layers in situ coupled together via lignin. In the illustrated example of FIG. 2D, the pieces are oriented such that fiber directions of adjacent pieces within a layer and between layers are aligned (e.g., parallel); however, other orientations are also possible. For example, FIG. 2E shows another engineered structure 238 formed by layering lignin-compromised plant material pieces 232a-232b, 234a-234c with fiber directions 236 crossing. As with the example of FIG. 2D, no separate adhesive is provided, and the subsequent pressing can densify the constituent pieces to form densified pieces 233a-233b, 235a-235c coupled together via the lignin from the constituent pieces.

Although FIGS. 2D-2E show a linear array of similarly sized/shaped pieces in each layer, embodiments of the disclosed subject matter are not limited thereto. Rather, in some embodiments, plant material pieces of different shapes and/or sizes, arranged in two dimensions, can be combined together in a single layer. Engineered structures can be formed from various plant material pieces, such as but not limited to wood (e.g., laminated wood board, or adhesive-free glulam) and bamboo (e.g., laminated bamboo board, or adhesive-free glubam 250 in FIG. 2G). Moreover, the size of the starting plant material pieces and/or the number of layers for the engineered structure can be selected to provide various thicknesses and/or lengths. For example, as shown in FIG. 2F, an engineered structure 240 can be fabricated to have a desired length for a particular application by staggering the constituent plant material pieces 242a, 244a before hot pressing, after which the lignin matrix 246 couples adjacent pieces together. For example, in situ glubam 252 can be fabricated with a length of at least 100 cm, as shown in FIG. 2H. Although FIGS. 2C-2H illustrate substantially planar shapes (e.g., rectangular prism), embodiments of the disclosed subject matter are not limited thereto. Rather, in some embodiments, one or more molds can be used to form (e.g., during the pressing to densify the plant material pieces and/or couple the pieces together) the engineered structure to have a curved or three-dimensional shape (e.g., arc, wave, polygon, etc.).

In any of the above noted examples, the constituent pieces within a layer of the unitary layered structure can be formed of a same plant material or different plant materials. Alternatively or additionally, in any of the above noted examples, one, some, or all of the constituent pieces of one layer can be formed of a same plant material or different plant materials from one, some, or all of the constituent pieces in another layer. Alternatively or additionally, in any of the above noted examples, the constituent pieces within a layer of the unitary layered structure can have a substantially similar shape (e.g., shaped as a strand or chip), a substantially similar size (e.g., a planar area and/or thickness within 20% of an average of pieces in the layer), and/or a substantially similar orientation (e.g., with fiber directions substantially parallel). Alternatively, in any of the above noted examples, the constituent pieces within a layer of the unitary layered structure can have different sizes, shapes, and/or orientations. Alternatively or additionally, in any of the above noted examples, one, some, or all of the constituent pieces of one layer can have a substantially similar shape, size, and/or orientation as one, some, or all of the constituent pieces in another layer. Alternatively, in any of the above noted examples, one, some, or all of the constituent pieces of one layer can have a different shape, size, and/or orientation as one, some, or all of the constituent pieces in another layer. In some embodiments, lignin-compromised plant material pieces can be combined with other plant material pieces (e.g., without lignin compromising or previously densified) and/or other structural materials (e.g., metal, non-densified wood, etc.).

For example, in some embodiments, pieces from different feedstocks (e.g., wood or branches thereof, bamboo or stalks thereof, grass, straw, wood waste, agricultural waste, etc.) can be mixed together within a layer or used in different layers in an engineered structure. In some embodiments, the orientations of pieces within each layer can be random, for example, to yield substantially isotropic properties. Alternatively, in some embodiments, the orientations of pieces within each layer can be substantially aligned, for example, to make a long board.

Alternatively or additionally, in some embodiments, the orientations of pieces within a layer and/or between layers can be such that their fiber directions cross (e.g., +45°/−45°direction), for example, to provide a structure that resists shear (e.g., a web of an I-beam or joist). In some embodiments, the size, shape, and/or type of pieces can be varied based on location within the final unitary structure, for example, with longer pieces arranged in top and/or bottom layers (e.g. to increase strength) and with shorter pieces arranged in middle layers (e.g., to increase packing density and/or reduce cost).

### Fabrication Methods

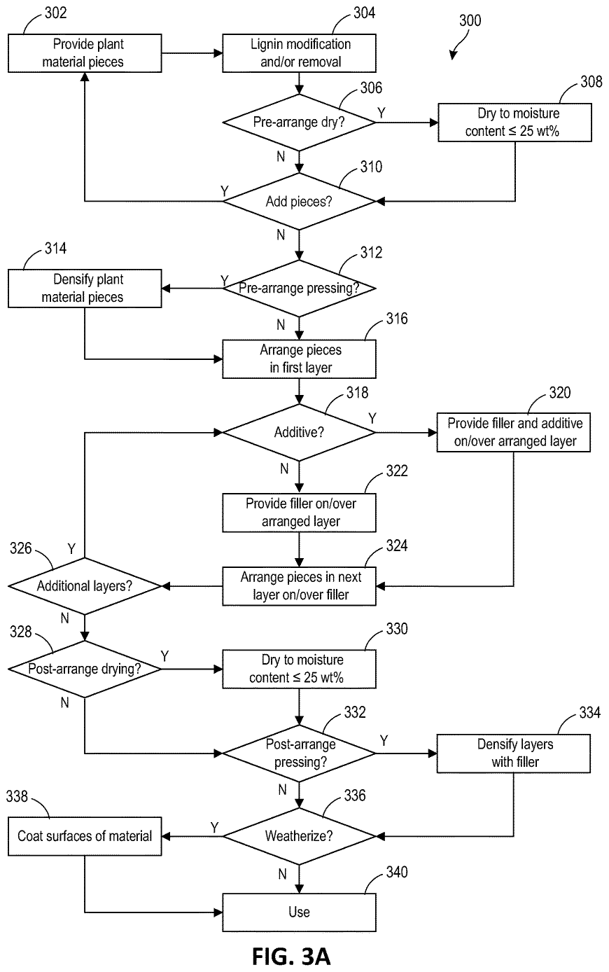

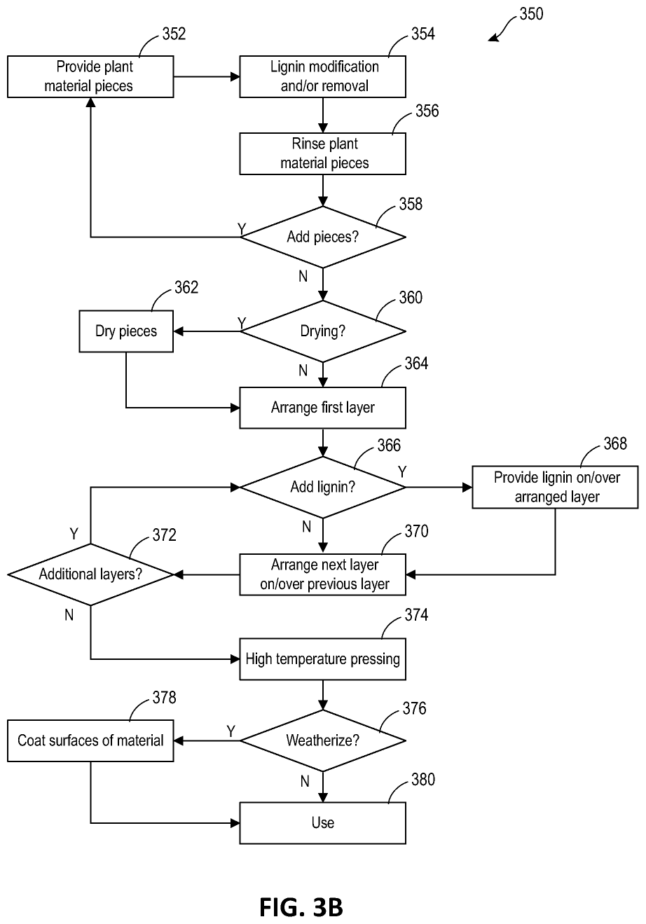

FIG. 3A illustrates aspects of a method 300 for fabricating an engineered structure from multiple plant material pieces. The method 300 can initiate at process block 302, where one or more plant material pieces can be provided. In some embodiments, the provision of process block 302 can include cutting, removing, or otherwise separating the piece from a parent plant. In some embodiments, the parent plant can be small diameter or young plant material (e.g., tree, bamboo stalk, etc.). In some embodiments, the cutting can form the plant material into strips, chips, or strands, for example, having a thickness less than or equal to 0.5 mm (e.g., 0.1-0.4 mm, inclusive). Optionally, in some embodiments, the preparing can include pre-processing of the piece of natural plant material, for example, cleaning to remove any undesirable material or contamination in preparation for subsequent processing, forming the natural plant material into a particular shape in preparation for subsequent processing (e.g., slicing into smaller strips), or any combination of the foregoing. Alternatively, in some embodiments, process block 302 can include providing grasses, branches, straw, wood waste, and/or agricultural waste as the plant material, and/or processing the provided plant material into pieces.

The method 300 can proceed to process block 304, where lignin within the provided plant material pieces can be subject to a lignin-compromising treatment, for example, partial delignification (for example, using the delignification processes disclosed in either U.S. Publication No. 2020/0223091 or U.S. Publication No. 2022/0412002, incorporated by reference above) and/or lignin modification (for example, using the lignin modification process described in International Publication No. WO 2023/028356).

For example, to perform in situ lignin modification, the plant material piece(s) can be infiltrated with one or more chemical solutions to modify lignin therein. For example, in some embodiments, the infiltration can be by soaking the plant material piece(s) in a solution containing the one or more chemicals under vacuum. In some embodiments, the chemical solution can contain at least one chemical component that has OH ions or is otherwise capable of producing OH ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+O₂, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO3+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing. In some embodiments, the concentration of the chemicals for lignin modification can be at a concentration of 5 wt % or less, for example, in a range of 1-4 wt %, inclusive. In some embodiments, the chemical infiltration can be performed without heating, e.g., at room temperature (20-30° C., such as ~22-23° C.). In some embodiments, the chemical solution is not agitated in order to avoid disruption to the native cellulose-based microstructure of the plant material piece(s).

For example, in some embodiments, plant material pieces(s) can be immersed in a chemical solution (e.g., 2-5% NaOH) in a container. The container can then be placed in a vacuum box and subjected to vacuum (e.g., 0.1 MPa). In this way, the air in the wood can be drawn out and form a negative pressure. When the vacuum pump is turned off, the negative pressure inside the plant material piece can suck the solution into the plant material piece through the natural channels therein (e.g., lumina defined by longitudinal cells). The process can be repeated more than once (e.g., 3 times), such that the channels inside the plant material piece can be filled with the chemical solution (e.g., about 2 hours). After this process, the moisture content can increase (e.g., from ~10.2% for natural wood to ~70% or greater).

The modification may be activated by subjecting the infiltrated plant material piece(s) to an elevated temperature, for example, greater than 80° C. (e.g., 100-180° C., such as 120-160° C.) and/or elevated pressure, thereby resulting in softened plant material piece(s) (e.g., softened as compared to the natural plant material piece(s)). In some embodiments, the heating can be achieved via steam heating, for example, via steam generated in an enclosed reactor (e.g., pressure reactor), via a steam flow in a flow-through reactor, and/or via steam from a superheated steam generator. Alternatively or additionally, in some embodiments, the heating of process block can be achieved via dry heating, for example, via conduction and/or radiation of heat energy from one or more heating elements without separate use of steam.

In some embodiments, the infiltrated plant material piece(s) can be subjected to the elevated temperature for a first time period of, for example, 1-10 hours (e.g., depending on the size of the plant material piece, with thicker pieces requiring longer heating times). In some embodiments, after the first time period, any steam generated by heating of the infiltrated plant material piece(s) can be released, for example, by opening a pressure release (e.g., relief valve) of the reactor. For example, in some embodiments, the pressure release can be effective to remove ~50% of moisture in the modified plant material piece(s). For example, in some embodiments, the now softened plant material piece(s) can have a moisture content in a range of 30-50 wt %, inclusive.

In some embodiments, the infiltration and heating of the plant material piece can be effective to modify the lignin therein, for example, by OH reacting with the phenolic hydroxyl group in lignin and breaking down the linking bonds of lignin macromolecules, which shortens the lignin macromolecular chains and softens the plant material piece. In addition, OH can also degrade hemicellulose by peeling reaction and can produce some acidic degradation products that can react with the alkaline solution (e.g., NaOH) and form neutral salts. In some embodiments, no black liquor is observed during the lignin modification process, and the degradation products from hemicellulose and lignin can be completely immobilized within the channels of the softened plant material piece. Since all chemicals are consumed in the process, the softened plant material piece can exhibit a neutral pH.

If partial delignification is instead desired for process block 304, the plant material piece(s) can be subjected to one or more chemical treatments to remove at least some lignin therefrom, for example, by immersion of the plant material piece(s) (or portion(s) thereof) in a chemical solution associated with the treatment. In some embodiments, each chemical treatment or only some chemical treatments can be performed under vacuum, such that the solution(s) associated with the treatment is encouraged to fully penetrate the cell walls and lumina of the plant material piece(s). Alternatively, in some embodiments, the chemical treatment(s) can be performed under ambient pressure conditions or elevated pressure conditions (e.g., ~6-8 bar). In some embodiments, each chemical treatment or some chemical treatments can be performed at any temperature between ambient (e.g., ~23° C.) and an elevated temperature where the solution associated with the chemical treatment is boiling (e.g., ~70-160° C.). In some embodiments, the solution is not agitated in order to minimize the amount of disruption to the native cellulose-based microstructure of the plant material piece(s).

In some embodiments, the immersion time can be in a range of 0.1 to 96 hours, inclusive, for example, 1-12 hours, inclusive. The amount of time of immersion within the solution may be a function of the amount of lignin to be removed, type of plant material, size of the plant material piece, temperature of the solution, pressure of the treatment, and/or agitation. For example, smaller amounts of lignin removal, smaller plant material piece size (e.g., cross-sectional thickness), higher solution temperature, higher treatment pressure, and agitation may be associated with shorter immersion times, while larger amounts of lignin removal, larger plant material piece size, lower solution temperature, lower treatment pressure, and no agitation may be associated with longer immersion times.

In some embodiments, the solution of the chemical treatment(s) can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), ozone (O₃), or any combination of the above. Exemplary combinations of chemicals for the chemical treatment can include, but are not limited to, NaOH+O₂, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+ acetic acid. For example, the first and second chemical solutions can be ≤2 wt % NaOH and Na₂SO₃ (e.g., formed by adding H₂SO₃ acid to NaOH).

The chemical treatment can continue (or can be repeated with subsequent solutions) until a desired reduction in lignin content in the plant material piece is achieved. In some embodiments, the lignin content can be reduced to between 5% (lignin content is 95% of original lignin content in the natural plant material) and 95% (lignin content is 5% of original lignin content in the natural plant material). In some embodiments, the chemical treatment reduces the hemicellulose content at the same time as the lignin content, for example, to the same or lesser extent as the lignin content reduction. In some embodiments, when the plant material piece is hardwood, the lignin content after the chemical treatment(s) for delignification can be at least 10 wt % (e.g., in a range of 10-15 wt %, inclusive). In some embodiments, when the plant material piece is softwood, the lignin content after the chemical treatment(s) for delignification can be at least 12.5 wt % (e.g., 12.5-17.5 wt %, inclusive). In some embodiments, when the plant material piece is bamboo, the lignin content after the chemical treatment(s) for delignification can be at least 13 wt % (e.g., 13-18 wt %, inclusive).

In some embodiments, rinsing can be used to remove residual chemicals or particulate(s) resulting from the chemical treatment(s). For example, the partially delignified plant material piece(s) can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration, or until a substantially neutral pH is measured for the chemically-treated plant material piece(s).

After the lignin-compromising treatment of process block 304, the method 300 can proceed to decision block 306, where it is determined if drying is desired before arranging the lignin-compromised plant material pieces into layers. If drying is desired, the method 300 can proceed to process block 308, where the plant material piece(s) can optionally be dried to reduce the moisture content of the plant material piece(s), for example, without removing too much moisture that the plant material piece lose its softened nature (e.g., such that the moisture content is greater than or equal to ~15 wt %). In some embodiments, the optional drying of process block 308 may be effective to reduce a moisture content of the plant material piece(s) from greater than 30 wt % (e.g., 30-50 wt %) to less than 25 wt %, for example, about 20 wt %.

The drying of process block 308 can include any of conductive, convective, and/or radiative heating processes, including but not limited to an air-drying process, a vacuum-assisted drying process, an oven drying process, a freeze-drying process, a critical point drying process, a microwave drying process, or any combination of the above. For example, an air-drying process can include allowing the processed plant material piece(s) to naturally dry in static or moving air, which air may be at any temperature, such as room temperature (e.g., 23° C.) or at an elevated temperature (e.g., greater than 23° C.). For example, a vacuum-assisted drying process can include subjecting the processed plant material piece(s) to reduced pressure, e.g., less than 0.1 MPa, for example, in a vacuum chamber or vacuum oven. For example, an oven drying process can include using an oven, hot plate, or other conductive, convective, or radiative heating apparatus to heat the processed plant material piece(s) at an elevated temperature (e.g., greater than 23° C.), for example, 70° C. or greater. For example, a freeze-drying process can include reducing a temperature of the processed plant material piece(s) to below a freezing point of the fluid therein (e.g., less than 0 ° C.), then reducing a pressure to allow the frozen fluid therein to sublime (e.g., less than a few millibars). For example, a critical point drying process can include immersing the processed plant material piece(s) in a fluid (e.g., liquid carbon dioxide), increasing a temperature and pressure of the plant material piece(s) past a critical point of the fluid (e.g., 7.39 MPa, 31.1° C. for carbon dioxide), and then gradually releasing the pressure to remove the now gaseous fluid. For example, a microwave drying process can include using a microwave oven or other microwave generating apparatus to induce dielectric heating within the processed plant material piece(s) by exposing it to electromagnetic radiation having a frequency in the microwave regime (e.g., 300 MHz to 300 GHz), for example, a frequency of ~915 MHz or ~2.45 GHz.

After the drying of process block 308, or if no drying was desired at decision block 306, the method 300 can proceed to decision block 310, where it is determined if additional pieces are desired. If additional pieces are desired, for example, to provide pieces of different plant materials, different shapes, and/or different sizes, or to provide additional pieces of the same plant material, the method 300 can return to process block 302 via decision block 310.

Otherwise, the method 300 can proceed to decision block 312, where it is determined if the plant material pieces should be densified prior to arranging.

If pre-arrange pressing is desired, the method 300 can proceed to process block 314, where the lignin-compromised plant material pieces are subjected to densification. For example, the lignin-compromised plant material piece can be pressed in a direction crossing its fiber direction. In some embodiments, the pressing can be in a direction substantially perpendicular to the fiber direction, while in other embodiments the pressing may have a force component perpendicular to the fiber direction. In either case, the pressing can be effective to reduce a thickness of the plant material piece(s), thereby increasing its density as well as collapsing (at least partially) the natural lumina (e.g., vessels, lumen in each fiber, parenchyma cells, etc.), voids, and/or gaps within the cross-section of the plant material piece(s). In some embodiments, the pressing can be along a single direction (e.g., along radial direction R), for example, to reduce a thickness of the lignin-compromised plant material piece(s) (e.g., at least a 5:2 reduction in dimension as compared to the plant material piece(s) prior to pressing). Alternatively or additionally, in some embodiments, the plant material piece(s) can be simultaneously pressed in two orthogonal directions (e.g., both perpendicular to the fiber direction), for example, to reduce a cross-sectional area of the plant material piece(s) (e.g., to produce a densified rectangular strip). Alternatively or additionally, in some embodiments, the plant material piece(s) can be sequentially pressed in different orthogonal directions.

In some embodiments, the pressing may be performed without any prior drying of the plant material piece(s) or with the plant material piece(s) retaining at least some water or other fluid therein. The pressing can thus be effective to remove at least some water or other fluid from the plant material piece(s) at the same time as its dimension is reduced and density increased. The pressure and timing of the pressing can be a factor of the size of plant material piece(s) prior to pressing, the desired size of the plant material piece(s) after pressing, the water or fluid content within the plant material piece(s) (if any), the temperature at which the pressing is performed, relative humidity, and/or other factors. For example, the plant material piece(s) can be held under pressure for a time period of 1 minute up to several hours (e.g., 1-180 minutes, inclusive). In some embodiments, the plant material piece(s) can be held under pressure for 3-72 hours, inclusive. In some embodiments, the pressing can be performed at a pressure between 0.5 MPa and 20 MPa, inclusive, for example, 5 MPa. In some embodiments the pressing may be performed without heating (e.g., cold pressing), while in other embodiments the pressing may be performed with heating (e.g., hot pressing). For example, the pressing may be performed at a temperature between 20° C. and 160° C., e.g., greater than or equal to 100° C.

In some embodiments, the pressing can be effective to fully collapse the lumina of the native cellulose-based microstructure of the plant material and/or can result in a density for the compressed plant material of at least 1 g/cm³ (e.g., ≥1.1 g/cm³ or ≥1.2 g/cm³, for example, in a range of 1.3-1.5 g/cm³).

After the densification of process block 314, or if no pressing was desired at decision block 312, the method 300 can proceed to process block 316, where some of the plant material pieces can be arranged in a first layer. In some embodiments, the plant material pieces can be arranged in a single layer within a frame or mold. In some embodiments, the plant material pieces can be arranged to have a predetermined orientation for their fiber directions, for example, aligned (e.g., substantially parallel) or crossing (e.g., orthogonal). Alternatively, in some embodiments, the plant material pieces can be arranged to have random orientations (e.g., to yield a layer with substantially isotropic properties).

The method 300 can proceed to decision block 318, where it is determined if an additive is desired. For example, in some embodiments, the additive can be a fire retardant, such as but not limited to antimony trioxide, magnesium hydroxide, aluminum hydroxide, borate, tributyl phosphate, tris (2-ethylhexyl) phosphate, tris(2-chloroethyl) phosphate, tricresyl phosphate, and triphenyl phosphate. If an additive is desired, the method 300 can proceed to process block 320, where the additive can be combined with the filler and applied on/over the arranged layer of plant material pieces. Alternatively, the additive may be applied on/over the arranged layer of plant material pieces prior to or after the filler is applied. Otherwise, the method 300 can proceed from decision block 318 to process block 322, where the filler is applied on/over the arranged layer of plant material pieces. In some embodiments, instead of applying the filler and/or additive over the layer after arranging, the plant material pieces can be coated (partially or fully) in the filler and/or additive prior to being arranged in a layer.

In either process block 320 or process block 322, the filler can be a polysaccharide. In some embodiments, the polysaccharide can have a plurality of polar functional groups that originate from an organic acid, for example, carboxyl and/or hydroxyl groups. In some embodiments, the filler can comprise a polysaccharide of anhydroglucose or a derivative thereof, for example, starch, chitin, chitosan, cellulose, carboxymethyl cellulose, methyl cellulose, ethyl hydroxyethyl cellulose, hydroxyethyl cellulose, or hydroxypropyl methylcellulose.

Alternatively or additionally, the filler can comprise sodium alginate, xanthan gum, guar gum, carrageenan, or gum arabic. In some embodiments, the amount of filler applied is such that a content of filler in the final unitary layered structure is less than or equal to 5 wt %, for example, in a range of 1-5 wt %.

The method 300 can proceed to process block 324, where some of the plant material pieces can be arranged in a next layer over the first layer with filler thereon. In some embodiments, the plant material pieces can be arranged atop the previously arranged layer within the frame or mold. In some embodiments, the plant material pieces in the next layer can be arranged to have a predetermined orientation for their fiber directions within the layer, for example, aligned (e.g., substantially parallel) or crossing (e.g., orthogonal) within the layer. In some embodiments, the plant material pieces in the next layer can be arranged to have a predetermined orientation for their fiber directions with respect to the previous layer, for example, aligned (e.g., substantially parallel) or crossing (e.g., orthogonal) with respect to the previous layer. Alternatively, in some embodiments, the plant material pieces can be arranged to have random orientations (e.g., to yield a layer with substantially isotropic properties).

The method 300 can proceed to decision block 326, where it is determined if additional layers are desired. For example, in some embodiments, layers can be added to yield a predetermined or desired thickness for the final unitary layered structure (e.g., a thickness greater than 2 cm). If additional layers are desired, the method 300 can return to decision block 318 via decision block 326. Otherwise, the method 300 can proceed to decision block 328, where it is determined if optional drying is desired after the arranging of the plant material piece(s) in layers.

If post-arrange drying is desired, the method 300 can proceed to process block 330, where the layers of plant material piece(s) can be dried to reduce the moisture content of the plant material pieces, for example, without removing too much moisture that the plant material piece lose its softened nature (e.g., such that the moisture content is greater than or equal to ~15 wt %). In some embodiments, the drying of process block 330 may be effective to reduce a moisture content of the plant material piece(s) from greater than 30 wt % (e.g., 30-50 wt %) to within less than 25 wt %, for example, about 20 wt %. The drying of process block 330 can include any of conductive, convective, and/or radiative heating processes, including but not limited to an air-drying process, a vacuum-assisted drying process, an oven drying process, a microwave drying process, or any combination of the above, for example, similar to as described above with respect to process block 308.

After the drying of process block 330, or if no drying was desired at decision block 328, the method 300 can proceed to decision block 332, where it is determined if the layers plant material pieces should be subjected to pressing. If post-arrange pressing is desired, the method 300 can proceed to process block 334, where the layers of plant material pieces are simultaneously pressed together, for example, to densify the stack and/or the constituent plant material pieces therein. For example, the plant material pieces can be pressed in a direction crossing a direction in which the layers are stacked. In some embodiments, the pressing can be in a direction substantially perpendicular to the layer stacking direction, while in other embodiments the pressing may have a force component perpendicular to the layer stacking direction. In some embodiments, the pressing can be along a single direction, for example, to reduce a thickness of the layered stack. Alternatively or additionally, in some embodiments, the layers can be simultaneously pressed in two orthogonal directions, for example, to reduce a cross-sectional area of the layered stack. Alternatively or additionally, in some embodiments, the layers can be sequentially pressed in different orthogonal directions.

In some embodiments, the pressing of process block 334 may be performed without any prior drying of the plant material pieces or with the plant material pieces retaining at least some water or other fluid therein. The pressing can thus be effective to remove at least some water or other fluid from the plant material pieces at the same time as the dimension of the stack is reduced and density increased. In some embodiments, the pressing can be effective to couple together adjacent layers via the filler, which can enhance bonding by providing increased points for the formation of hydrogen bonds with the cellulose of the constituent plant material pieces. The pressure and timing of the pressing can be a factor of the size of layers prior to pressing, the desired size of the layered stack after pressing, the water or fluid content within the plant material pieces (if any), the temperature at which the pressing is performed, relative humidity, the characteristics of the filler and/or additive (if any), and/or other factors. For example, the layers can be held under pressure for a time period of 1 minute up to several hours (e.g., 1-180 minutes, inclusive). In some embodiments, the layers can be held under pressure for 3-72 hours, inclusive. In some embodiments, the pressing can be performed at a pressure between 0.5 MPa and 20 MPa, inclusive, for example, 5 MPa. In some embodiments the pressing may be performed without heating (e.g., cold pressing), while in other embodiments the pressing may be performed with heating (e.g., hot pressing). For example, the pressing may be performed at a temperature between 20° C. and 160° C., e.g., greater than or equal to 50° C. In some embodiments, the pressing can be effective to fully collapse the lumina of the native cellulose-based microstructure of the plant material and/or can result in a density for the layered stack of at least 1 g/cm³ (e.g., ≥1.1 g/cm³ or ≥1.2 g/cm³, for example, in a range of 1.3-1.5 g/cm³). In some embodiments, the pressing of process block 334 can form the layered structure to have a non-planar shape (e.g., a curved shape or other complex 3-D shape), for example, by using an appropriately shaped mold.

After the densification of process block 334, or if no pressing was desired at decision block 332, the method 300 can proceed to decision block 336, where it is determined if weatherization or other coating is desired for the layered structure, for example, a waterproof or at least water resistant coating. If weatherization or other coating is desired, the method 300 can proceed to process block 338, where a coating can be applied to one or more external surfaces of the layered structure. For example, the waterproof coating can include polyurethane, varnish, lacquer, tung oil, and/or polymerized linseed oil.

After the coating of process block 338, or if no coating was desired at decision block 336, the method 300 can proceed to process block 340, where the unitary layered structure can optionally be machined, cut, transported, and/or otherwise physically manipulated in preparation for eventual use. Machining processes can include, but are not limited to, cutting (e.g., sawing), drilling, woodturning, tapping, boring, carving, routing, sanding, grinding, and abrasive tumbling. Manipulating process can include, but are not limited to, bending, molding, and other shaping techniques. In some embodiments, process block 340 can also include use of the layered structure as an engineered material in a particular application. For example, the engineered structure can be adapted for use as structural material (e.g., a load bearing component or a non-load bearing component). One of ordinary skill in the art will readily appreciate that the engineered structures disclosed herein can be readily adapted for use in various applications based on the teachings of the present disclosure.

Although blocks 302-340 of method 300 have been described as being performed once, in some embodiments, multiple repetitions of a particular process block may be employed before proceeding to the next decision block or process block. In addition, although blocks 302-340 of method 300 have been separately illustrated and described, in some embodiments, process blocks may be combined and performed together (simultaneously or sequentially). Moreover, although FIG. 3A illustrates a particular order for blocks 302-340, embodiments of the disclosed subject matter are not limited thereto. Indeed, in certain embodiments, the blocks may occur in a different order than illustrated or simultaneously with other blocks. In some embodiments, method 300 can include steps or other aspects not specifically illustrated in FIG. 3A. Alternatively or additionally, in some embodiments, method 300 may comprise only some of blocks 302-340 of FIG. 3A.

FIG. 3B illustrates aspects of another method 350 for fabricating an engineered structure from multiple plant material pieces. The method 350 can initiate at process block 352, where one or more plant material pieces can be provided. In some embodiments, the provision of process block 352 can include cutting, removing, or otherwise separating the piece from a parent plant. In some embodiments, the parent plant can be wood or bamboo. In some embodiments, the cutting can form the plant material into strips, panels, or blocks, for example, having a thickness less than or equal to 5 mm (e.g., 0.1-2.0 mm, inclusive). Optionally, in some embodiments, the preparing can include pre-processing of the piece of natural plant material, for example, cleaning to remove any undesirable material or contamination in preparation for subsequent processing, forming the natural plant material into a particular shape in preparation for subsequent processing (e.g., slicing into smaller strips), or any combination of the foregoing.

The method 350 can proceed to process block 354, where lignin within the provided plant material pieces can be subject to a lignin-compromising treatment, for example, as described above with respect to process block 304 of method 300. Alternatively, in some embodiments, the lignin-compromising treatment can be effective to remove some lignin while modifying the retained lignin. For example, the plant material piece(s) can be infiltrated with one or more chemical solutions. For example, in some embodiments, the infiltration can be by soaking the plant material piece(s) in a solution containing the one or more chemicals under vacuum. In some embodiments, the chemical solution can contain at least one chemical component that has OH ions or is otherwise capable of producing OH ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+O₂, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing. In some embodiments, the concentration of the chemicals for lignin modification can be at a concentration of 10 wt % or greater, for example, in a range of 15-25 wt %, inclusive. In some embodiments, the chemical infiltration can be performed without heating, e.g., at room temperature (20-30° C., such as ~22-23° C.). In some embodiments, the chemical solution is not agitated in order to avoid disruption to the native cellulose-based microstructure of the plant material piece(s). In some embodiments, the infiltration under vacuum can continue for several hours (e.g., 12 hours) and/or be repeated multiple times.

The infiltrated plant material piece(s) can then be subjected to an elevated temperature, for example, greater than 80° C. (e.g., 100-180° C., such as 120-160° C.) and/or elevated pressure, thereby resulting in softened plant material piece(s) (e.g., softened as compared to the natural plant material piece(s)). In some embodiments, the heating can be achieved via heating in autoclave. Alternatively or additionally, in some embodiments, the heating of process block can be achieved via dry heating, for example, via conduction and/or radiation of heat energy from one or more heating elements without separate use of steam. In some embodiments, the infiltrated plant material piece(s) can be subjected to the elevated temperature for a first time period of, for example, 1-10 hours (e.g., depending on the size of the plant material piece, with thicker pieces requiring longer heating times and/or desired degree of lignin removal). In some embodiments, after the first time period, the pressure in the autoclave can be released, for example, by opening a pressure release (e.g., relief valve) of the reactor. In some embodiments, the infiltration and heating of the plant material piece can be effective to remove some lignin while modifying the retained lignin, for example, such that the retained lignin has more exposed functional groups on its surface as compared to native lignin. For example, the content of lignin retained in the softened plant material piece(s) can be in a range of 15-20 wt %, inclusive.

The method 350 can proceed to process block 356, where rinsing can be performed, for example, to remove residual chemicals, dissolved lignin, and/or dissolved hemicellulose. For example, the softened plant material piece(s) can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration, or until a substantially neutral pH is measured.

The method 350 can proceed to decision block 358, where it is determined if additional pieces are desired. If additional pieces are desired, for example, to provide pieces of different plant materials, different shapes, and/or different sizes, or to provide additional pieces of the same plant material, the method 350 can return to process block 352 via decision block 358.

Otherwise, the method 350 can proceed to decision block 360, where it is determined if the plant material pieces should be dried prior to arranging.

If pre-arrange drying is desired, the method 350 can proceed to process block 362, where the lignin-compromised plant material pieces are subjected to drying. In some embodiments, the drying may be similar that described above for process block 308 of method 300. Alternatively, in some embodiments, the plant material pieces are subjected to pressing to remove free water therefrom. For example, the pressing can be performed at room temperature, at a pressure of 20 MPa or less, and/or for a duration of 60 minutes or less (e.g., 40-60 minutes).

After the drying of process block 362, or if drying was not desired at decision block 360, the method 350 can proceed to process block 364, where some of the plant material pieces can be arranged in a first layer. In some embodiments, the plant material pieces can be arranged in a single layer. In some embodiments, the plant material pieces can be arranged to have a predetermined orientation for their fiber directions, for example, aligned (e.g., substantially parallel). Alternatively, in some embodiments, the plant material pieces can be arranged to have crossing orientations (e.g., orthogonal) or random orientations (e.g., to yield a layer with substantially isotropic properties).

The method 350 can proceed to process block 366, where it is determined if additional lignin is desired. For example, in some embodiments, the additional lignin can be kraft lignin. If additional lignin is desired, the method 350 can proceed to process block 368, where the additional lignin can be applied on/over the arranged layer of plant material pieces. In some embodiments, instead of applying the additional lignin over the layer after arranging, the plant material pieces can be coated (partially or fully) in the additional lignin prior to being arranged in a layer. Alternatively or additionally, the provision of process block 368 can include providing an additive, such as a fire retardant, for example, in a manner similar to that described above for process block 320 of method 300.

After applying the additional lignin in process block 368, or if additional lignin was not desired at decision block 366, the method 350 can proceed to process block 370, where some of the plant material pieces can be arranged in a next layer over the previously arranged layer. In some embodiments, the plant material pieces in the next layer can be arranged to have a predetermined orientation for their fiber directions within the layer, for example, aligned (e.g., substantially parallel) or crossing (e.g., orthogonal) within the layer. In some embodiments, the plant material pieces in the next layer can be arranged to have a predetermined orientation for their fiber directions with respect to the previous layer, for example, aligned (e.g., substantially parallel) or crossing (e.g., orthogonal) with respect to the previous layer. Alternatively, in some embodiments, the plant material pieces can be arranged to have random orientations (e.g., to yield a layer with substantially isotropic properties).

The method 350 can proceed to process block 372, where it is determined if additional layers are desired. For example, in some embodiments, layers can be added to yield a predetermined or desired size (e.g., thickness or length) for the final unitary layered structure. If additional layers are desired, the method 350 can return to decision block 366 via decision block 372. Otherwise, the method 350 can proceed to process block 374, where the layers are subjected to high temperature pressing.

In the high temperature pressing of process block 374, the layers of plant material pieces are simultaneously pressed together, for example, to densify the constituent plant material pieces and to couple adjacent pieces together via the modified lignin therein. For example, the plant material pieces can be pressed in a direction crossing a direction in which the layers are stacked and/or the fiber directions of the pieces. In some embodiments, the pressing can be in a direction substantially perpendicular to the layer stacking direction and/or fiber directions, while in other embodiments the pressing may have a force component perpendicular to the layer stacking direction and/or fiber directions. In some embodiments, the pressing can be along a single direction, for example, to reduce a thickness of the layered stack. Alternatively or additionally, in some embodiments, the layers can be simultaneously pressed in two orthogonal directions, for example, to reduce a cross-sectional area of the layered stack. Alternatively or additionally, in some embodiments, the layers can be sequentially pressed in different orthogonal directions.

The pressure, temperature, and timing of the pressing can be a factor of the glass transition temperature of the lignin, the size of layers prior to pressing, the desired size of the layered stack after pressing, the water or fluid content within the plant material pieces (if any), relative humidity, and/or other factors. In some embodiments, the pressing is performed at a temperature exceeding the glass transition temperature of lignin, for example, in a range of 120-180° C. (e.g., 130-150° C., inclusive). For example, the layers can be held under pressure for a time period of 1 minute up to several hours (e.g., 1-180 minutes, inclusive). In some embodiments, the layers can be held under pressure for 10-30 minutes, inclusive, for example, about 20 minutes. In some embodiments, the pressing can be performed at a pressure between 0.5 MPa and 50 MPa, inclusive, for example, about 20 MPa. In some embodiments, the pressing can be effective to fully collapse the lumina of the native cellulose-based microstructure of the plant material and/or can result in a density for the layered stack of at least 1 g/cm³ (e.g., ≥1.1 g/cm³ or ≥1.2 g/cm³, for example, in a range of 1.3-1.5 g/cm³).

After the pressing of process block 374, the method 350 can proceed to decision block 376, where it is determined if weatherization or other coating is desired for the layered structure, for example, a waterproof or at least water resistant coating. If weatherization or other coating is desired, the method 350 can proceed to process block 378, where a coating can be applied to one or more external surfaces of the layered structure. For example, the waterproof coating can include polyurethane, varnish, lacquer, tung oil, and/or polymerized linseed oil.

After the coating of process block 378, or if no coating was desired at decision block 376, the method 350 can proceed to process block 380, where the unitary layered structure can optionally be machined, cut, transported, and/or otherwise physically manipulated in preparation for eventual use. Machining processes can include, but are not limited to, cutting (e.g., sawing), drilling, woodturning, tapping, boring, carving, routing, sanding, grinding, and abrasive tumbling. Manipulating process can include, but are not limited to, bending, molding, and other shaping techniques. In some embodiments, process block 380 can also include use of the layered structure as an engineered material in a particular application. For example, the engineered structure can be adapted for use as structural material (e.g., a load bearing component or a non-load bearing component). One of ordinary skill in the art will readily appreciate that the engineered structures disclosed herein can be readily adapted for use in various applications based on the teachings of the present disclosure.

Although blocks 352-380 of method 350 have been described as being performed once, in some embodiments, multiple repetitions of a particular process block may be employed before proceeding to the next decision block or process block. In addition, although blocks 352-380 of method 350 have been separately illustrated and described, in some embodiments, process blocks may be combined and performed together (simultaneously or sequentially). Moreover, although FIG. 3B illustrates a particular order for blocks 352-380, embodiments of the disclosed subject matter are not limited thereto. Indeed, in certain embodiments, the blocks may occur in a different order than illustrated or simultaneously with other blocks. In some embodiments, method 350 can include steps or other aspects not specifically illustrated in FIG. 3B. Alternatively or additionally, in some embodiments, method 300 may comprise only some of blocks 352-380 of FIG. 3B.

### Fabricated Examples and Experimental Results

### Wood Oriented Strand Board Examples

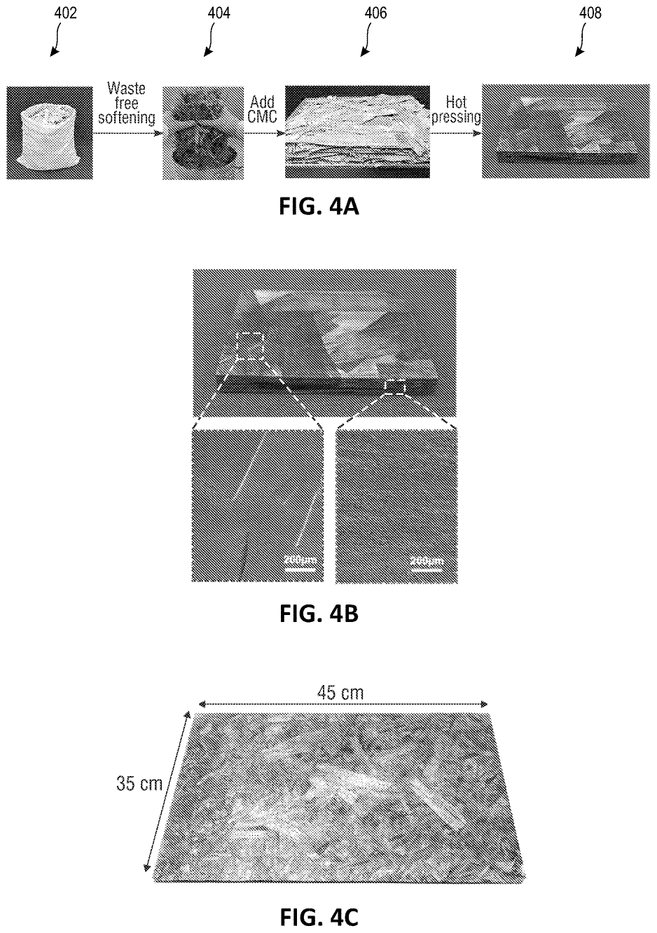

Referring to FIG. 4A, a fabrication process followed to form a densified-wood oriented strand board (OSB) is shown. A small-diameter tree was chosen as the raw material, and the wood was cut into thin strips 402. A waste-free softening process was then applied to the wood strips to modify the lignin therein. In particular, 3% NaOH was infused into the channels of the natural wood strips under 0.1 MPa vacuum, and the chemical-filled wood strips were heated at 160° C. in a steam-heated reactor (without any additional chemicals). After heating, the reactor pressure was relieved, leading to about 50% moisture removal in the treated wood samples 404. The waste-free softening process did not produce any liquid waste; rather, all the depolymerized fragments of lignin and hemicellulose were immobilized in the channels of the softened wood strips. In addition, all of the NaOH reacted with lignin and hemicellulose during the heating process, generating a softened wood with a neutral pH (evaluated using squeezed liquid for the softened wood).

As shown at 406, the softened wood strips were then stacked layer by layer in a mold, with filler provided between each layer. In particular, carboxymethyl cellulose (CMC) was selected as the filler, and was added such that the concentration of CMC in the final structure was less than 5 wt % (e.g., about 3 wt %). The wood strips in each layer were randomly arranged (e.g., with respect to fiber direction), such that the final structure was substantially isotropic.

The stacked arrangement of softened wood strips and filler was then subjected to compression (e.g., along a direction in which the layers were stacked and/or substantially perpendicular to the fiber directions) to form the unitary layered structure 408. The compression was performed at a pressure of about 5 MPa and a temperature of about 120° C. for about 3 hours.

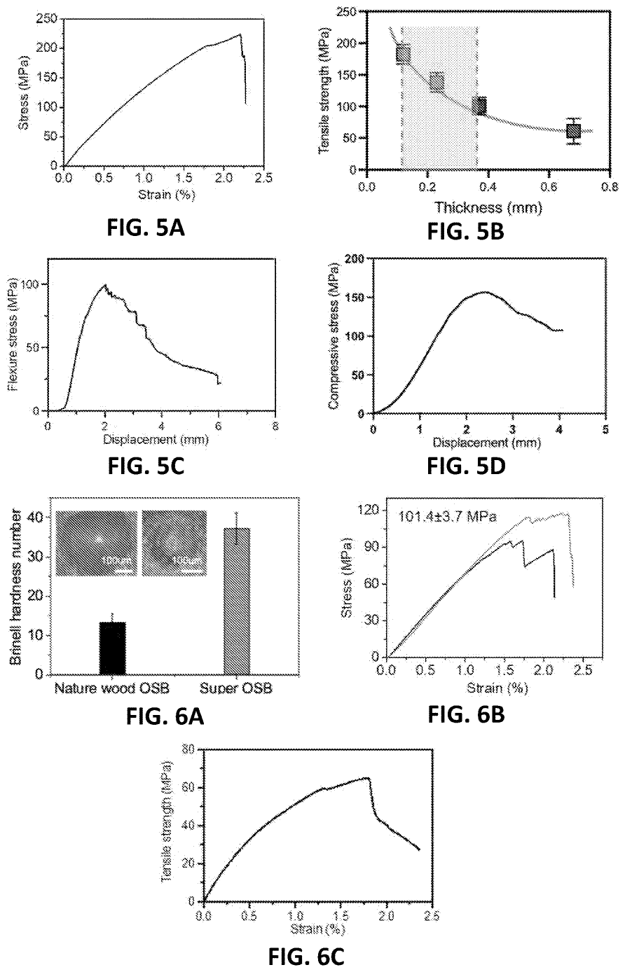

As shown in FIG. 4B, the unitary layered structure after compression exhibited smooth external surfaces and a densified internal structure in cross-section. The disclosed technique can be used to create OSB of any size, for example, 35 cm×45 cm, as shown in FIG. 4C. As shown in FIG. 5A, the densified-wood OSB exhibited a high strength of ~220 MPa in all directions, which is about 22 times that of conventional OSB. Moreover, as shown in FIGS. 5C-5D, the flexural strength and compressive strength of the densified-wood OSB were ~100 MPa and ~155 MPa, which are 5 times and 10 times higher than those of conventional OSB, respectively. The strength of the resulting unitary layered structure can be altered by changing the thickness of the constituent plant material pieces. FIG. 5B illustrates the relationship between wood strip thickness (e.g., the initial wood strips 402 prior to softening) and measured tensile strength of the densified-wood OSB. As shown in FIG. 5B, thinner wood pieces can yield a layered structure with increased tensile strength.

FIG. 6A compares the Brinell hardness of OSB formed using natural wood and the densified-wood OSB 408 (Super OSB) using the process of FIG. 4A. The natural wood OSB was prepared by coating natural wood strips using 1% CMC solution, arranging in a mold layer-by-layer in random orientations, and then hot pressing. As shown in FIG. 6A, the densified-wood OSB exhibited significantly greater hardness than that of natural wood OSB. The fabrication process of FIG. 4A also exhibited enhanced mechanical properties as compared to other fabrication processes. For example, FIG. 6B shows stress-strain curves for OSB formed from pre-densified wood strips and CMC. In particular, natural wood strips (length of about 5-10 cm, width of about 1-4 cm, thickness of about 300-1000 μm) were subjected to lignin modification, and the resulting softened strips were then densified (5 MPa pressure at about 120° C. for 15 minutes) to form the densified wood strips (thickness decreased to about 25-33% of the original thickness). These densified wood strips were coated with 2% CMC solution and stacked layer-by-layer in random orientations, and the stack was then pressed under 5 MPa at about 120° C. for 3 hours to form the pre-densified-wood OSB samples (CMC content of about 3%). As suggested by comparing the results of FIGS. 5A and 6B, the densified wood OSB prepared by the process of FIG. 4A unexpectedly exhibits significantly greater tensile strength than that of pre-densified-wood OSB (e.g., about 220 MPa versus about 101 MPa), despite being comprised of the same constituent materials.

FIG. 6C shows a stress-strain curve for OSB formed from pre-densified wood strips and epoxy. In particular, natural wood strips (length of about 5-10 cm, width of about 1-4 cm, thickness of about 300-1000 μm) were subjected to lignin modification, and the resulting softened strips were then densified (5 MPa pressure at about 120° C. for 15 minutes) to form the densified wood strips (thickness decreased to about 25-33% of the original thickness). These densified wood strips were coated with epoxy glue (J-B Weld ClearWeld 5 minute epoxy) and stacked layer-by-layer in random orientations, and the stack was then pressed under 5 MPa at about 65° C. for 0.5 hours to form a pre-densified-wood OSB (epoxy content of about 8%). As suggested by comparing the results of FIGS. 5A and 6C, the densified wood OSB prepared by the process of FIG. 4A unexpectedly exhibits significantly greater tensile strength than that of pre-densified-wood OSB prepared with conventional adhesives (e.g., about 220 MPa versus about 65 MPa), despite both using densified wood.

### In Situ Glubam Examples

To fabricate laminated bamboo with in situ lignin bonding (referred to as in situ glubam), natural bamboo strips (40 mm×10 mm×2 mm) were immersed in 20 wt % NaOH aqueous solution for 12 hours under vacuum. The bamboo strips were then autoclaved at 160° C. for 1 hour (liquid-to-bamboo ratio of 5:1). After autoclaving, the strips were immersed in deionized (DI) water several times to remove residual chemicals as well as any dissolved lignin and hemicellulose. After this process, the mass loss of natural bamboo was 41.4 wt % due to partial removal of the lignin and hemicelluloses from the bamboo matrix. Two sheets of these softened bamboo strips were then stacked along the axial (parallel to the fiber growth) direction and bonded together via hot-pressing (a temperature in a range of 120-180° C., for example, 140° C., and a pressure of about 20 MPa) to form the final in situ glubam, which featured an approximately 94.2% increase in density compared with natural bamboo.

The wet-chemistry treatment significantly reduces the functional groups present in softened bamboo and in situ glubam compared to natural bamboo. Specifically, the characteristic functional groups of lignin, which are represented by peaks at 1593, 1505, and 1462 cm⁻¹, as well as the functional groups of hemicellulose peaks at 1736 and 1235 cm⁻¹, are attenuated in the softened bamboo and in situ glubam. This suggests that the hemicelluloses and lignin content of the softened bamboo and in situ glubam are lower than those of the natural bamboo. For a more quantitative analysis of the different components, an acid hydrolysis method was performed. Compared with the natural bamboo starting material, the lignin and hemicellulose contents of the softened bamboo decreased from 29.8±1.5% to 17.5±2.7% and 22.5±1.1% to 11.5±1.5%, respectively, demonstrating the effectiveness of the wet-chemistry treatment. After hot-pressing, the resulting in situ glubam was mainly composed of cellulose (72.5±2.5%) with remaining lignin (18.3±2.2%) and hemicelluloses (8.6±1.4%).

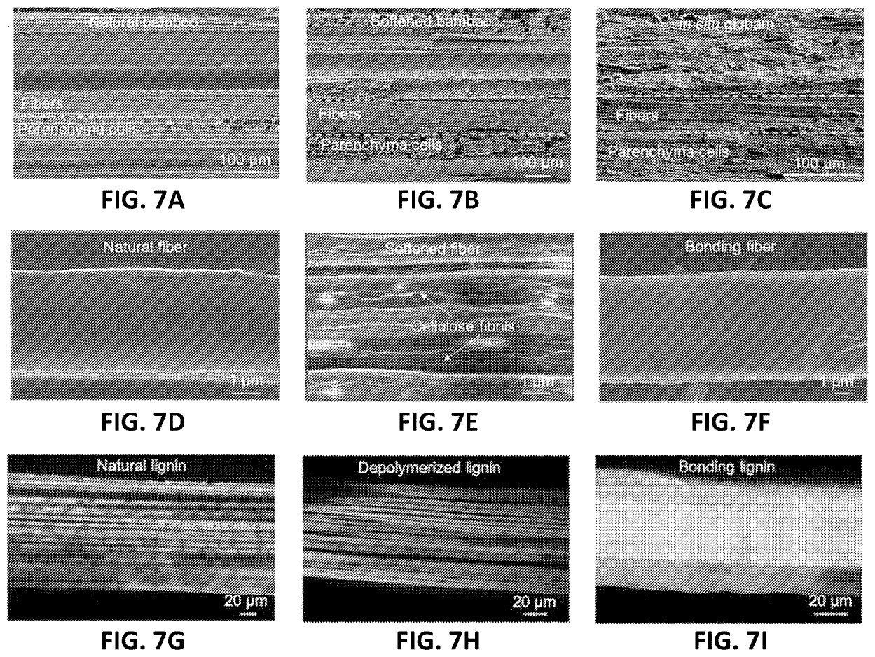

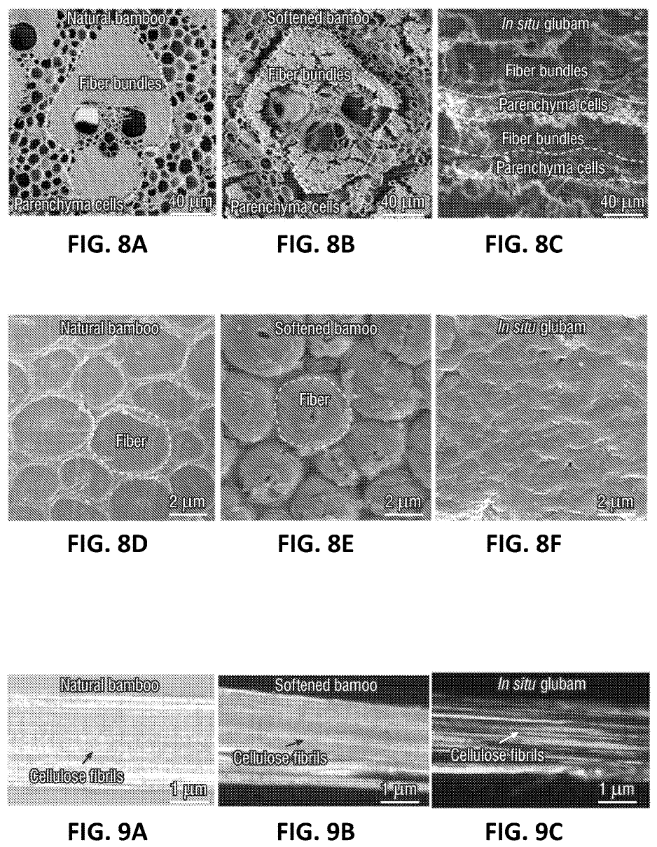

Scanning electron microscopy (SEM) revealed the structural evolution from natural bamboo to in situ glubam. As shown in FIG. 7A, in the natural bamboo material, the long fibers are remarkably well-aligned and parallel to the growth direction, and the short parenchyma cells are neatly stacked around the fiber bundles. As shown by the cross-section of natural bamboo in FIGS. 8A and 8D, the fiber bundles have many solid elementary fibers surrounded by hollow parenchyma cells. In the magnified view of a single fiber of natural bamboo in FIG. 7D, the fiber is fairly smooth without visible pores. Each fiber has cellulose fibrils within an amorphous matrix of lignin and hemicelluloses.

Polarization microscopy was used to observe the morphology of the cellulose fibrils, which demonstrated bright birefringence under polarized light. As shown by the polarized image in FIG. 9A, the natural cellulose fibrils are well aligned along the growth direction of the bamboo. Additionally, confocal fluorescence microscopy was used to observe the distribution of lignin, which combined intensity from excitation of 405 nm, 488 nm, 561 nm, and 640 nm. FIG. 7G shows that lignin is continuous and uniformly distributed around the bamboo fiber bundles. After partially removing lignin and hemicelluloses by the wet-chemistry treatment, the fibers and the cell walls of the parenchyma cells become more porous, separating from each other and creating voids in the adhesive matrix between the cells of the softened bamboo sample, as shown in FIGS. 7B, 8B, and 8E. Nanocellulose fibrils and nanopores appear between the fibers at the nanometer level, in which cellulose fibrils become curly and soft, with more cellulose fibril surface exposed, as shown in FIGS. 7E and 9B). The wet-chemistry treatment also partially removes lignin, breaking up the formerly continuous lignin distribution, as shown in FIG. 7H.

After the hot-pressing process, the porous cell walls and fiber bundles collapse completely, forming a highly dense structure along the bamboo growth direction in the in situ glubam, as shown in FIGS. 7C, 8C, and 8F. At higher magnifications, as shown in FIG. 7F, it can be seen that the voids of the softened fibers have disappeared, forming densified bonding fibers. Additionally, as shown in FIG. 7I, the lignin is aggregated and becomes more uniform again, with almost no visible gaps suggesting a compact, highly entangled structure. Under the action of hot pressing, the lignin penetrates into the voids of the cellulose fibers that had been opened by the wet-chemistry process and homogeneously spreads over fiber surface, which acts as a bonding agent within the in situ glubam by physically entangling with the highly oriented fibers to form a strong and tough matrix.

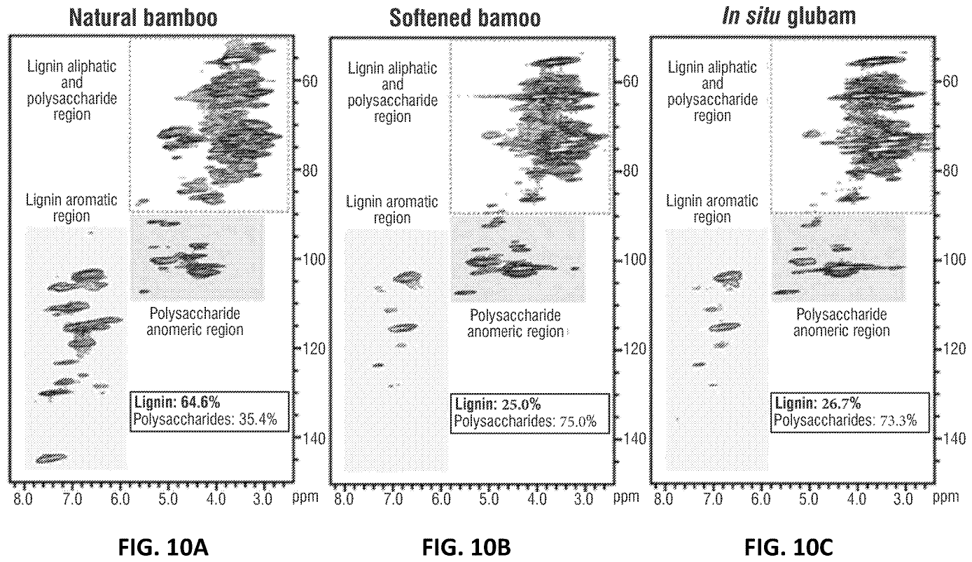

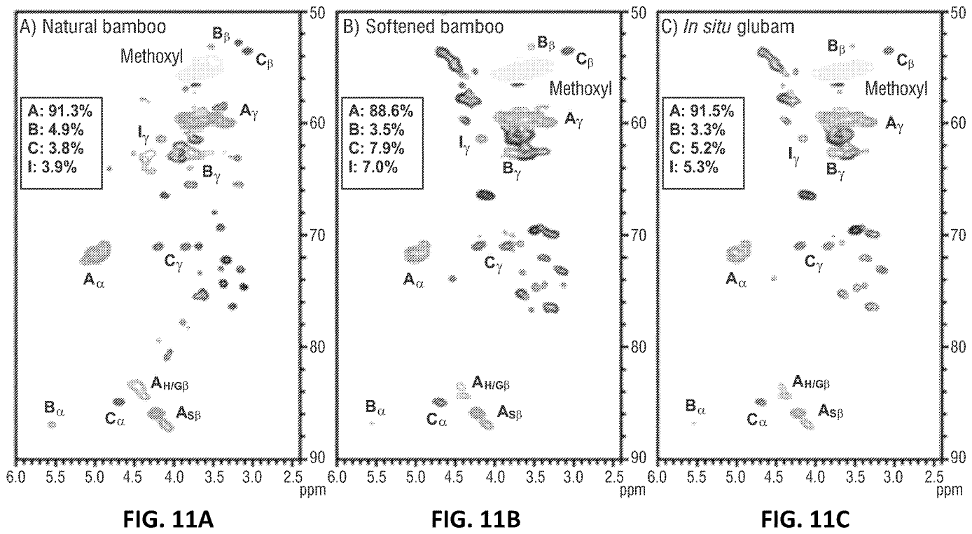

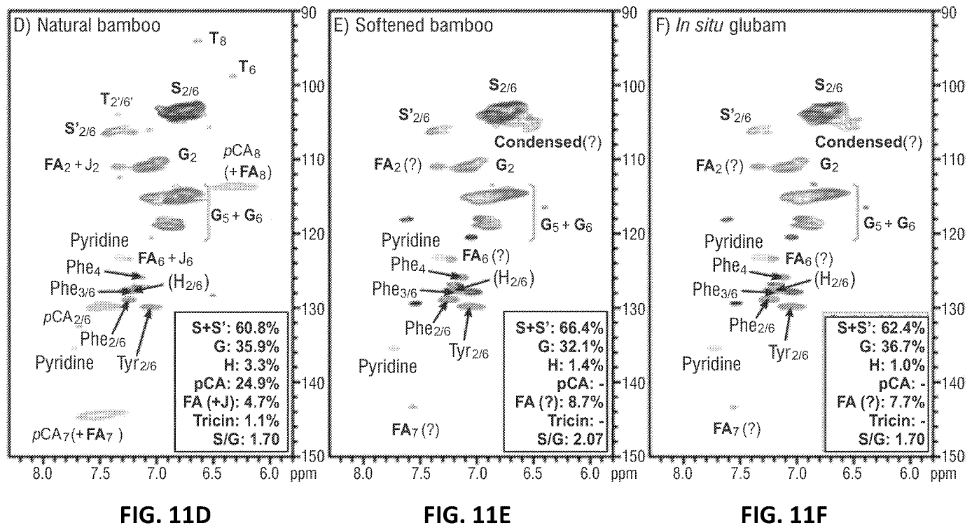

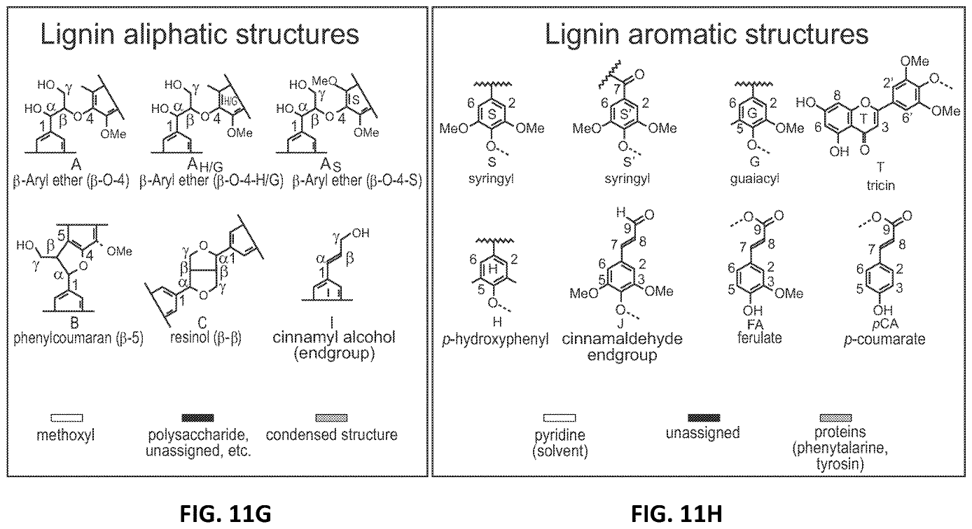

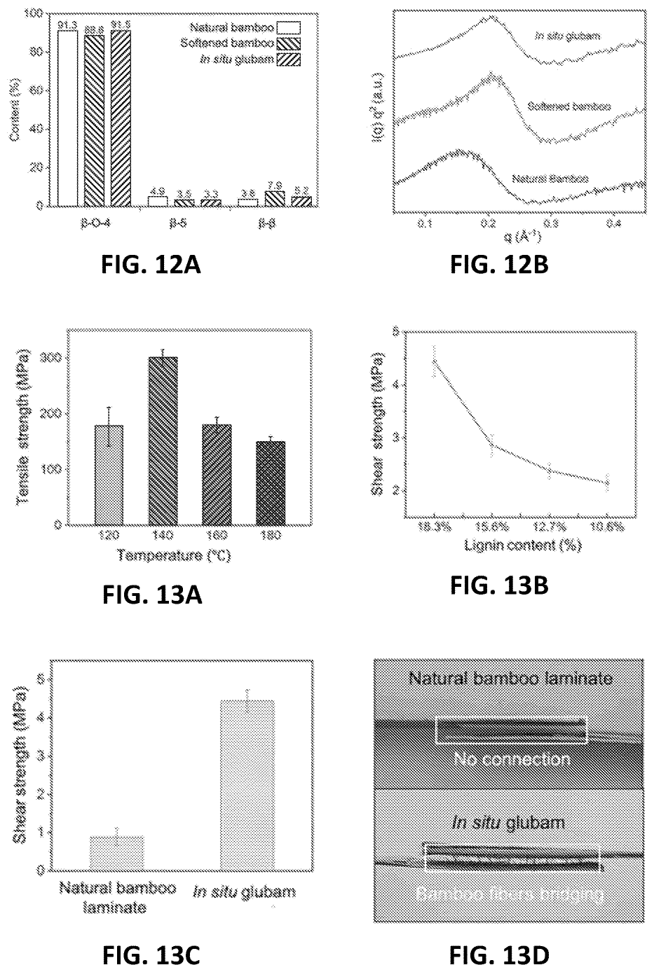

To gain further insight into the molecular structure transformation of lignin during the two-step treatment, 2D nuclear magnetic resonance (NMR) spectra was collected for the natural bamboo, delignified bamboo, and in situ glubam. Lignin is made up of phenylpropane monomeric units that are connected primarily by ether bonds (e.g., β-O-4) and carbon-carbon bonds (e.g., β-β, β-5). As shown in FIGS. 10A-10C and 12, despite a decrease in the overall amount of lignin following the treatments, no significant changes were observed in the linkages. In the in situ glubam, the β-O-4 ether bond accounts for ~91.3% of the total ether linkages of the lignin. In the side-chain region, syringyl (S), guaiacyl (G), and p-hydroxyphenyl (H) in substructures are linked via β-O-4, β-β, and β-5 bonds, respectively, as shown in FIGS. 11A-11H. Probable condensation peaks appeared near the S2/6-units after the delignification process. Lignin depolymerization generated and exposed more active sites (functional groups such as phenolic hydroxyl) on the lignin surface. This increase in active sites not only strengthens the hydrogen bonding between lignin and cellulose but also improves the self-bonding reactivity of the lignin fragments under hot pressing.

X-ray diffraction was used to analyze the nanostructures of cellulose macrofibres in natural bamboo, softened bamboo, and in situ glubam. Small-angle X-ray scattering (SAXS) was used to determine the molecular alignment of the cellulose chains that comprise the nanofibrils. FIG. 12B shows the SAXS curves, plotted using the scattered intensity perpendicular to the fibril direction as a function of the scattering vector q, defined as q=(4π/λ)sinθ, with λ and θ being the X-ray wavelength and half of the scattering angle, respectively. Inter-fibril distances d can be quantified using the Bragg's law d=2π/qₘ, where qₘ is the q-value at the peak position in the SAXS curves. The calculated inter-fibril distances are 40.9, 31.6, and 30.3 nm for natural bamboo, softened bamboo, and in situ glubam, respectively. The inter-fiber distance of the in situ glubam is 25.9% lower than that of natural bamboo and is close to that of dry softened bamboo. In the dry state of the softened bamboo, cellulose microfibrils tend to be in close contact, due to the lowering of the lignin content between the microfibrils. The major effect of hot-pressing was that it strengthened the cellulose microfibril ‘bondage’ mediated by the remaining lignin molecules, thereby enhancing the cross-linking hydrogen bonding force between the cellulose-cellulose and cellulose-lignin in the in situ glubam.

Two-dimensional wide-angle X-ray scattering (2D WAXS) was used to examine the organization of cellulose chains in crystalline. Cellulose I remained as the predominant crystal polymorph in the softened bamboo and in situ glubam, as revealed by indexing the Bragg's peaks in the WAXS data. In addition, cellulose crystalline orientation degree was calculated, based on the azimuthal scan of the scattered intensity in the vicinity of the (200) reflection, using Hermans's orientation function, denoted P₂. In particular, the P₂ values of the natural bamboo and in situ glubam were 0.90 and 0.81, respectively, suggesting that crystals in the in situ glubam are more misoriented-an effect due to the high-pressure processing. Such misorientation might be able to cause microfibril entanglement, which is another factor that accounts for enhanced mechanical performance.

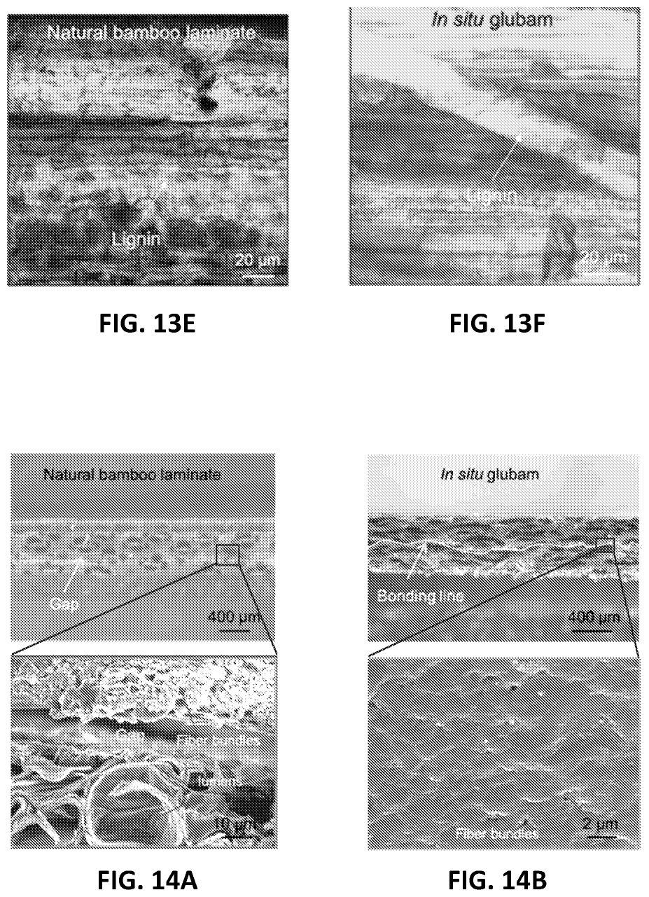

The tensile mechanical properties of the in situ glubam were investigated at different hot-pressing temperatures (e.g., 120, 140, 160, and 180° C.). As shown in FIG. 13A, the in situ glubam exhibited a maximum tensile strength of 300±15 MPa at a hot-pressing temperature of 140° C., likely because this temperature is close to the glass transition temperature of lignin. Moreover, tensile testing showed that the strength of the in situ glubam gradually increases as the thickness of the constituent pieces decreases, for example, reaching a maximum of about 300±15 MPa for pieces having a thickness of 0.25 mm. The tensile strength of the in situ glubam was about 280 MPa for constituent pieces having a thickness of about 1 mm, and about 250 MPa for constituent pieces having a thickness of about 2 mm.

The macroscopic tensile shear adhesion strength of the in situ glubam was also evaluated at different degrees of delignification by controlling alkaline treatment time using a lap shear test. When the lignin content was 18.3%±2.2% (treated for 1 hour), the interfacial bonding strength reached a maximum value of 4.4±0.3 MPa, as shown in FIG. 13B. With a decrease in the lignin content, the interfacial bonding strength of the in situ glubam gradually decreased.

There were still gaps between the nanofibers that could not be completely closed at the molecular level in the in situ glubam without lignin. The absence of a dense structure in the composite indicates that lignin plays a key role as an adhesive agent. However, when a natural bamboo laminate was prepared in which no alkaline treatment was applied (i.e., when only hot pressing at 140° C. was applied), the material displayed a shear strength of just 0.88 MPa, as shown in FIG. 13C. FIG. 13D shows that there was no penetration or embedment observed in the natural bamboo laminate after conducting the shear strength test. In contrast, it was observed from the interfacial joints of the in situ glubam after the shear strength test that a large number of oriented fiber bundles of bamboo were peeled off, which played a major role in connecting and bridging the two bamboo strips after hot pressing.

The morphology of the natural bamboo laminate and in situ glubam were observed. As suggested by FIG. 14A, it was challenging to hot-press the natural bamboo laminate into a completely compact structure. Despite applying 20 MPa of pressure, there were still many gaps between the lumens and fiber bundles. In contrast, the in situ glubam has a densified microstructure, in which the fully collapsed fiber bundles are tightly packed along their cross-section, as shown in FIG. 14B. Additionally, fluorescence imaging of lignin on the adhesion interface of the natural bamboo laminate in FIG. 13E shows that the lignin is in a dispersed state, despite the fact the fluorescence intensity of lignin is very high. In contrast, fluorescence imaging of lignin on the adhesion interface of in situ glubam in FIG. 13F shows that the surface lignin clumps together, particularly in the bamboo fiber part. These results suggest that lignin cannot achieve bonding by hot pressing directly without alkaline treatment.

As shown in FIG. 2H, a large in situ glubam board was prepared with a dimension of 100 cm by 7 cm by 1.2 mm using the delignification and hot-pressing treatment without the addition of any additional adhesives. By stacking the softened bamboo strips, the in situ glubam can be fabricated to different lengths sufficient for practical use (e.g., up to 1 meter long). Even at these larger sizes, the mechanical properties of the in situ glubam remain stable. Stress-strain curves of randomly selected small samples containing nodes from a large in situ glubam board show similar tensile strength of 195±30 MPa. In addition, applying additional lignin (e.g., kraft lignin) and resin (e.g., epoxy) at the interface can further improve the interfacial binding between sheets of bamboo laminate. The mechanical test results show that the tensile strength of in situ glubam was improved, reaching 245+21 MPa and 357±17 MPa, respectively, even though only 5 wt % kraft lignin or epoxy were added.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. An engineered structure comprising:
a plurality of pieces of plant material arranged to form at least two layers, at least some of the pieces being lignin-compromised plant material; and
a filler or bonding agent coupling together adjacent pieces of the plant material so as to form a unitary layered structure,
wherein the filler comprises a polysaccharide or the bonding agent comprises lignin.
Clause 2. The engineered structure of any clause or example herein, in particular, Clause 1, wherein the polysaccharide has a plurality of polar functional groups that originate from an organic acid.
Clause 3. The engineered structure of any clause or example herein, in particular, Clause 2, wherein the plurality of polar functional groups comprises carboxyl groups, hydroxyl groups, or both carboxyl and hydroxyl groups.
Clause 4. The engineered structure of any clause or example herein, in particular, any one of Clauses 1-3, wherein the polysaccharide comprises a polysaccharide of anhydroglucose or a derivative thereof.
Clause 5. The engineered structure of any clause or example herein, in particular, any one of Clauses 1-4, wherein the polysaccharide is starch, chitin, chitosan, cellulose, carboxymethyl cellulose, methyl cellulose, ethyl hydroxyethyl cellulose, hydroxyethyl cellulose, or hydroxypropyl methylcellulose.
Clause 6. The engineered structure of any clause or example herein, in particular, any one of Clauses 1-4, wherein the polysaccharide comprises carboxymethyl cellulose.
Clause 7. The engineered structure of any clause or example herein, in particular, any one of Clauses 1-4, wherein the polysaccharide is sodium alginate, xanthan gum, guar gum, carrageenan, or gum arabic.
Clause 8. The engineered structure of any clause or example herein, in particular, any one of Clauses 1-7, wherein a content of the filler in the unitary layered structure is less than or equal to 5 wt %.
Clause 9. The engineered structure of any clause or example herein, in particular, any one of Clause 1-8, wherein a content of the filler is in a range of 1-5 wt %.
Clause 10. The engineered structure of any clause or example herein, in particular, any one of Clauses 1-9, wherein one or more of the pieces of plant material is formed of wood or bamboo.
Clause 11. The engineered structure of any clause or example herein, in particular, any one of Clauses 1-10, wherein one or more of the pieces of plant material is formed of grass, straw, or hemp.
Clause 12. The engineered structure of any clause or example herein, in particular, any one of Clauses 1-11, wherein:
the at least two layers are stacked along a thickness direction of the unitary layered structure; and
each piece of plant material has a longitudinal direction along which cellulose fibers therein are substantially aligned.
Clause 13. The engineered structure of any clause or example herein, in particular, Clause 12, wherein the longitudinal directions of at least some of the pieces of plant material within one of the at least two layers are non-parallel.
Clause 14. The engineered structure of any clause or example herein, in particular, any one of Clauses 12-13, wherein the longitudinal directions of at least some of the pieces of plant material within one of the at least two layers are substantially parallel.
Clause 15. The engineered structure of any clause or example herein, in particular, any one of Clauses 12-14, wherein:
the longitudinal directions of at least some of the pieces of plant material within one of the at least two layers cross at a predetermined angle; and/or
the longitudinal direction of one of the pieces of plant material within one of the at least two layers crosses at a predetermined angle the longitudinal direction of one of the pieces of plant material within another of the at least two layers.
Clause 16. The engineered structure of any clause or example herein, in particular, any one of Clauses 1-15, wherein a size, shape, and/or type of plant material for one of the pieces of plant material within a first layer of the at least two layers is different from that of another of the pieces of plant material within the first layer.
Clause 17. The engineered structure of any clause or example herein, in particular, any one of Clauses 1-16, wherein a size, shape, and/or type of plant material for one of the pieces of plant material within one of the at least two layers is different from that of another of the pieces of plant material within another of the at least two layers.
Clause 18. The engineered structure of any clause or example herein, in particular, any one of Clauses 1-17, wherein the filler fills gaps between and within adjacent one of the pieces of plant material, and/or the filler provides additional bonding points for hydrogen bond formation with cellulose fibers.
Clause 19. The engineered structure of any clause or example herein, in particular, any one of Clauses 1-18, wherein a thickness of the unitary layered structure, along a direction in which the at least two layers are stacked, is at least 2 cm.
Clause 20. The engineered structure of any clause or example herein, in particular, any one of Clauses 1-19, wherein a tensile strength of the unitary layered structure is a least 100MPa.
Clause 21. The engineered structure of any clause or example herein, in particular, any one of Clauses 1-20, wherein a tensile strength of the unitary layered structure is at least 200 MPa.
Clause 22. The engineered structure of any clause or example herein, in particular, any one of Clauses 1-21, wherein at least some of the plurality of pieces of plant material are shaped as chips or strands.
Clause 23. The engineered structure of any clause or example herein, in particular, any one of Clauses 1-22, wherein the lignin-compromised plant material comprises at least partially delignified plant material.
Clause 24. The engineered structure of any clause or example herein, in particular, Clause 23, where a lignin content of the at least partially delignified plant material is between 5% and 95%, inclusive, of a native lignin content of corresponding natural plant material.
Clause 25. The engineered structure of any clause or example herein, in particular, any one of Clauses 23-24, wherein:
the plant material is a hardwood or bamboo, and a lignin content of the at least partially delignified plant material is between 0.9 wt % and 23.8 wt %, inclusive; or
the plant material is a softwood, and a lignin content of the at least partially delignified plant material is between 1.25 wt % and 33.25 wt %, inclusive.
Clause 26. The engineered structure of any clause or example herein, in particular, any one of Clauses 23-25, wherein a lignin content of the at least partially delignified plant material is at least 10 wt %.
Clause 27. The engineered structure of any clause or example herein, in particular, any one of Clauses 1-26, wherein the lignin-compromised plant material comprises modified lignin therein, and the modified lignin has shorter macromolecular chains than that of native lignin in corresponding natural plant material.
Clause 28. The engineered structure of any clause or example herein, in particular, Clause 27, wherein a content of the modified lignin in one, some, or all of the pieces of lignin-compromised plant material is at least 90%, on a weight percentage basis, of a content of the native lignin in the natural plant material.
Clause 29. The engineered structure of any clause or example herein, in particular, any one of Clauses 27-28, wherein a content of the modified lignin in one, some, or all of the pieces of lignin-compromised plant material is at least 20 wt %.
Clause 30. The engineered structure of any clause or example herein, in particular, any one of Clauses 27-29, wherein one, some, or all of the pieces of lignin-compromised plant material comprises a salt of an alkaline chemical immobilized within a cellulose-based microstructure of the lignin-compromised plant material.
Clause 31. The engineered structure of any clause or example herein, in particular, Clause 30, wherein the salt is substantially pH-neutral.
Clause 32. The engineered structure of any clause or example herein, in particular, any one of Clauses 1-31, wherein the unitary layered structure has a nonplanar shape.
Clause 33. The engineered structure of any clause or example herein, in particular, any one of Clauses 1-32, further comprising an environmental coating on one or more external surfaces of the unitary layered structure.
Clause 34. The engineered structure of any clause or example herein, in particular, Clause 33, wherein the environmental coating comprises polyurethane, varnish, lacquer, tung oil, polymerized linseed oil, epoxy, or any combination of the foregoing.
Clause 35. The engineered structure of any clause or example herein, in particular, any one of Clauses 1-34, further comprising a flame retardant disposed within the unitary layered structure and/or on one or more external surfaces of the unitary layered structure.
Clause 36. The engineered structure of any clause or example herein, in particular, Clause 35, wherein the flame retardant comprises antimony trioxide, magnesium hydroxide, aluminum hydroxide, borate, tributyl phosphate, tris(2-ethylhexyl) phosphate, tris(2-chloroethyl) phosphate, tricresyl phosphate, triphenyl phosphate, or any combination of the foregoing.
Clause 37. The engineered structure of any clause or example herein, in particular, any one of Clauses 1-36, wherein the unitary layered structure consists essentially of the plurality of pieces of plant material and the filler.
Clause 38. The engineered structure of any clause or example herein, in particular, Clause 1, wherein the lignin-compromised plant material has modified lignin, the modified lignin having more exposed functional groups on its surface as compared to native lignin of corresponding natural plant material, and the bonding agent comprises at least some of the modified lignin from the lignin-compromised plant material.
Clause 39. The engineered structure of any clause or example herein, in particular, Clause 38, wherein one or more of the pieces of plant material is formed of bamboo.
Clause 40. The engineered structure of any clause or example herein, in particular, any one of Clauses 38-39, wherein one or more of the pieces of plant material is formed of wood.
Clause 41. The engineered structure of any clause or example herein, in particular, any one of Clauses 38-40, wherein the at least some of the modified lignin is physically entangled with and bonded to cellulose nanofibrils of the adjacent pieces of the plant material.
Clause 42. The engineered structure of any clause or example herein, in particular, any one of Clauses 38-41, wherein a lignin content in the unitary layered structure is in a range of 15-20 wt %, inclusive.
Clause 43. The engineered structure of any clause or example herein, in particular, any one of Clauses 38-42, wherein:
a bonding strength between an adjacent pair of the at least two layers in the unitary layered structure is at least 4 MPa;
a tensile strength of the unitary layered structure is at least 200 MPa;
a shear strength of the unitary layered structure is at least 3 MPa; or
any combination of the above.
Clause 44. The engineered structure of any clause or example herein, in particular, any one of Clauses 38-43, wherein the bonding agent comprises additional lignin.
Clause 45. The engineered structure of any clause or example herein, in particular, Clause 44, wherein the additional lignin comprises kraft lignin.
Clause 46. A method comprising:
providing a plurality of pieces of plant material, at least some of the pieces being lignin-compromised plant material;
arranging the plurality of pieces of plant material in at least two layers; and
compressing the at least two layers so as to form a unitary layered structure.
Clause 47. The method of any clause or example herein, in particular, Clause 46, further comprising, after the providing and prior to the compressing, disposing a filler on one, some, or all of the plurality of pieces of plant material, wherein the filler comprises a polysaccharide.
Clause 48. The method of any clause or example herein, in particular, Clause 47, wherein the disposing the filler is performed between arranging of separate layers of the at least two layers.
Clause 49. The method of any clause or example herein, in particular, any one of Clauses 47-48, wherein during the disposing and/or the arranging, at least some of the pieces of plant material have a water content of at least 15 wt %.
Clause 50. The method of any clause or example herein, in particular, Clause 49, wherein the water content is in a range of 15-35 wt %.
Clause 51. The method of any clause or example herein, in particular, any one of Clauses 47-50, wherein the arranging comprises disposing the plurality of pieces of plant material within a mold.
Clause 52. The method of any clause or example herein, in particular, any one of Clauses 47-51, wherein the compressing is along a direction substantially perpendicular to a direction in which the at least two layers are stacked.
Clause 53. The method of any clause or example herein, in particular, any one of Clauses 47-52, wherein the compressing is at a pressure of at least 1 MPa.
Clause 54. The method of any clause or example herein, in particular, Clause 53, wherein the pressure is in a range of 5-20 MPa, inclusive.
Clause 55. The method of any clause or example herein, in particular, any one of Clauses 47-54, wherein, after the arranging and prior to the compressing, one, some, or all of the plurality of pieces of plant material have a thickness along a direction in which the at least two layers are stacked that is less than or equal to 0.5 mm.
Clause 56. The method of any clause or example herein, in particular, Clause 55, wherein the thickness is in a range of 0.1 to 0.4 mm, inclusive.
Clause 57. The method of any clause or example herein, in particular, any one of Clauses 47-56, wherein:
the polysaccharide has a plurality of polar functional groups that originate from an organic acid;
the plurality of polar functional groups comprises carboxyl groups, hydroxyl groups, or both carboxyl and hydroxyl groups;
the polysaccharide comprises a polysaccharide of anhydroglucose or a derivative thereof;
the polysaccharide comprises starch, chitin, chitosan, cellulose, carboxymethyl cellulose, methyl cellulose, ethyl hydroxyethyl cellulose, hydroxyethyl cellulose, or hydroxypropyl methylcellulose;
the polysaccharide comprises sodium alginate, xanthan gum, guar gum, carrageenan, or gum arabic; or
any combination of the above.
Clause 58. The method of any clause or example herein, in particular, any one of Clauses 47-57, wherein the polysaccharide comprises carboxymethyl cellulose.
Clause 59. The method of any clause or example herein, in particular, any one of Clauses 47-58, wherein a content of the filler in the unitary layered structure after the compressing is less than or equal to 5 wt %.
Clause 60. The method of any clause or example herein, in particular, any one of Clauses 47-59, wherein a content of the filler in the unitary layered structure after the compressing is in a range of 1-5 wt %.
Clause 61. The method of any clause or example herein, in particular, any one of Clauses 47-60, wherein one or more of the pieces of plant material is formed of wood, bamboo, grass, straw, or hemp.
Clause 62. The method of any clause or example herein, in particular, any one of Clauses 47-61, wherein:
each piece of plant material has a longitudinal direction along which cellulose fibers therein are substantially aligned; and
the arranging is such that longitudinal directions of at least some of the pieces of plant material within a layer or between layers are at a predetermined orientation.
63. The method of any clause or example herein, in particular, Clause 62, wherein the predetermined orientation is parallel or non-parallel.
Clause 64. The method of any clause or example herein, in particular, any one of Clauses 46-63, wherein the providing is such that a size, shape, and/or type of plant material for one of the pieces of plant material is different from that of another of the pieces of plant material.
Clause 65. The method of any clause or example herein, in particular, Clause 64, wherein the arranging is such that:
the size, shape, and/or type of plant material for one of the pieces of plant material within a first layer of the at least two layers is different from that of another of the pieces of plant material within the first layer;
the size, shape, and/or type of plant material for one of the pieces of plant material within one of the at least two layers is different from that of another of the pieces of plant material within another of the at least two layers; or
both of the above.
Clause 66. The method of any clause or example herein, in particular, any one of Clauses 47-65, wherein, after the compressing, the filler fills gaps between and within adjacent one of the pieces of plant material, and/or the filler provides additional bonding points for hydrogen bond formation with cellulose fibers.
Clause 67. The method of any clause or example herein, in particular, any one of Clauses 47-66, wherein the providing comprises subjecting pieces of natural plant material having native lignin therein to one or more chemical treatments so as to compromise the native lignin, thereby forming the pieces of lignin-compromised plant material.
Clause 68. The method of any clause or example herein, in particular, Clause 67, wherein, after the subjecting, the pieces of lignin-compromised plant material have modified lignin therein, and the modified lignin has shorter macromolecular chains than that of native lignin in the pieces of natural plant material.
Clause 69. The method of any clause or example herein, in particular, any one of Clauses 67-68, wherein the subjecting comprises:
infusing the pieces of natural plant material with one or more chemical solutions; and
after the infusing, exposing the pieces of natural plant material with the one or more chemical solutions therein to a first temperature of at least 100° C. for a first time, so as to form the pieces of lignin-compromised plant material.
Clause 70. The method of any clause or example herein, in particular, Clause 69, wherein the one or more chemical solutions comprise p-toluenesulfonic acid, NaOH, NaOH+O₂, NaOH+Na₂SO_{3/}Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.
Clause 71. The method of any clause or example herein, in particular, any one of Clauses 69-70, wherein:
the first temperature is in a range of 100-180° C., inclusive; and/or
the first time is in a range of 1-5 hours, inclusive.
Clause 72. The method of any clause or example herein, in particular, any one of Clauses 69-71, wherein at least 90% of the one or more chemical solutions infiltrated into the pieces of natural plant material is consumed by the subjecting to the first temperature for the first time.
Clause 73. The method of any clause or example herein, in particular, any one of Clauses 69-72, wherein the subjecting to the first temperature for the first time comprises using steam to heat the pieces of natural plant material with the one or more chemical solutions therein.
Clause 74. The method of any clause or example herein, in particular, any one of Clauses 69-73, wherein, after the subjecting to the first temperature for the first time:
a content of modified lignin in the pieces of lignin-compromised plant material is at least 90%, on a weight percentage basis, of a content of the native lignin in the pieces of natural plant material;
a content of modified lignin in the pieces of lignin-compromised plant material is at least 20 wt %; or
both of the above.
Clause 75. The method of any clause or example herein, in particular, any one of Clauses 69-74, wherein, after the subjecting to the first temperature for the first time, a salt of an alkaline chemical is immobilized within a cellulose-based microstructure of the pieces of lignin-compromised plant material.
Clause 76. The method of any clause or example herein, in particular, Clause 75, wherein the salt is substantially pH-neutral.
Clause 77. The method of any clause or example herein, in particular, any one of Clauses 75-76, wherein the salt is formed by reaction of the one or more chemical solutions with an acidic degradation product of native hemicellulose in the pieces of natural plant material produced by the one or more chemical solutions.
Clause 78. The method of any clause or example herein, in particular, any one of Clauses 67-77, wherein, after the subjecting to a chemical treatment, the pieces of lignin-compromised plant material is at least partially delignified.
Clause 79. The method of any clause or example herein, in particular, Clause 78, wherein the subjecting to the chemical treatment comprises partial or full immersion of the pieces of natural plant material in one or more chemical solutions at a second temperature for a second time, so as to remove at least some lignin from the pieces of natural plant material.
Clause 80. The method of any clause or example herein, in particular, Clause 79, wherein the one or more chemical solutions comprise an alkaline solution.
Clause 81. The method of any clause or example herein, in particular, Clause 80, wherein the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N2O), sodium bisulfite (NaHSO₃), NaH₂O₃, sulfur dioxide (SO₂), anthraquinone (C₁₄H₈O2), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), ozone (O₃), or any combination of the foregoing.
Clause 82. The method of any clause or example herein, in particular, any one of Clauses 80-81, wherein the one or more chemical solutions comprise a boiling mixture of NaOH and Na₂SO₃.
Clause 83. The method of any clause or example herein, in particular, any one of Clauses 79-82, wherein:
the second temperature is in a range of 100-160° C., inclusive;
the second time is in a range of 0.1-96 hours, inclusive; or
both of the above.
Clause 84. The method of any clause or example herein, in particular, any one of Clauses 79-83, wherein a lignin content of the pieces of lignin-compromised plant material is between 5% and 95%, inclusive, of a lignin content of the pieces of natural plant material.
Clause 85. The method of any clause or example herein, in particular, any one of Clauses 79-84, wherein:
the native plant material is a hardwood or bamboo, and a lignin content of the pieces of lignin-compromised plant material is between 0.9 wt % and 23.8 wt %, inclusive; or
the native plant material is a softwood, and a lignin content of the pieces of lignin-compromised plant material is between 1.25 wt % and 33.25 wt %, inclusive.
Clause 86. The method of any clause or example herein, in particular, any one of Clauses 79-85, wherein a lignin content of the pieces of lignin-compromised plant material is at least 10 wt %.
Clause 87. The method of any clause or example herein, in particular, any one of Clauses 46-86, wherein the compressing forms the unitary layered structure into a nonplanar shape.
Clause 88. The method of any clause or example herein, in particular, any one of Clauses 46-87, further comprising, after the providing and prior to the compressing, disposing a flame retardant on one, some, or all of the plurality of pieces of plant material.
Clause 89. The method of any clause or example herein, in particular, Clause 88, wherein the flame retardant comprises antimony trioxide, magnesium hydroxide, aluminum hydroxide, borate, tributyl phosphate, tris(2-ethylhexyl) phosphate, tris(2-chloroethyl) phosphate, tricresyl phosphate, triphenyl phosphate, or any combination of the foregoing.
Clause 90. The method of any clause or example herein, in particular, any one of Clauses 46-89, further comprising providing an environmental coating on one or more external surfaces of the unitary layered structure.
Clause 91. The method of any clause or example herein, in particular, Clause 90, wherein the environmental coating comprises polyurethane, varnish, lacquer, tung oil, polymerized linseed oil, epoxy, or any combination of the foregoing.
Clause 92. The method of any clause or example herein, in particular, any one of Clauses 46-91, wherein one or more of the pieces of plant material is formed of bamboo or wood.
Clause 93. The method of any clause or example herein, in particular, any one of Clauses 46-92, wherein:
the lignin-compromised plant material has modified lignin with more exposed functional groups on its surface as compared to native lignin of corresponding natural plant material, and
the compressing is such that the at least some of the modified lignin from the lignin-compromised plant material acts as a bonding agent to couple together adjacent pieces of the plant material in the unitary layered structure.
Clause 94. The method of any clause or example herein, in particular, Clause 93, wherein, after the compressing, the at least some of the modified lignin is physically entangled with and bonded to cellulose nanofibrils of the adjacent pieces of the plant material.
Clause 95. The method of any clause or example herein, in particular, any one of Clauses 93-94, wherein, after the compressing, a lignin content in the unitary layered structure is in a range of 15-20 wt %, inclusive.
Clause 96. The method of any clause or example herein, in particular, any one of Clauses 93-95, wherein the providing comprises subjecting pieces of natural plant material having native lignin therein to one or more chemical treatments so as to remove at least some lignin and/or modify remaining lignin, thereby forming the pieces of lignin-compromised plant material.
Clause 97. The method of any clause or example herein, in particular, Clause 96, wherein the subjecting comprises:
infusing pieces of natural plant material with one or more chemical solutions at room temperature;
after the infusing, exposing the pieces of natural plant material with the one or more chemical solutions therein to a third temperature of at least 100° C. for a third time; and
after the subjecting, rinsing the pieces to remove residual chemicals, dissolved lignin, and/or dissolved hemicellulose.
Clause 98. The method of any clause or example herein, in particular, Clause 97, wherein the subjecting further comprises, after the rinsing, removing water from the pieces by drying and/or pressing at room temperature.
Clause 99. The method of any clause or example herein, in particular, any one of Clauses 97-98, wherein the one or more chemical solutions comprise p-toluenesulfonic acid, NaOH, NaOH+O₂, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.
Clause 100. The method of any clause or example herein, in particular, any one of Clauses 97-99, wherein the one or more chemical solutions is an aqueous solution containing at least 10 wt % NaOH.
Clause 101. The method of any clause or example herein, in particular, any one of Clauses 97-100, wherein:
the third temperature is in a range of 100° C. to 180° C., inclusive; and/or the third time is in a range of 1-5 hours, inclusive.
Clause 102. The method of any clause or example herein, in particular, any one of Clauses 97-101, wherein the exposing to the third temperature is performed in an autoclave or a steam reactor at a pressure greater than atmospheric pressure.
Clause 103. The method of any clause or example herein, in particular, any one of Clauses 93-102, wherein the compressing is performed at a pressure of at least 10 MPa and a temperature in a range of 120-180° C., inclusive, for a duration of at least 10 minutes.
Clause 104. The method of any clause or example herein, in particular, Clause 103, wherein, the pressure of the compressing is at least 20 MPa, the temperature of the compressing is in a range of 130-150° C., inclusive, and/or the duration of the compressing is at least 20 minutes.
Clause 105. The method of any clause or example herein, in particular, any one of Clauses 93-104, wherein the compressing is performed at a temperature greater than a glass transition temperature of the modified lignin.
Clause 106. The method of any clause or example herein, in particular, any one of Clauses 93-105, wherein, after the providing and prior to the compressing, each of the plurality of pieces of plant material has a thickness along a direction in which the at least two layers are stacked that is less than or equal to 2 mm.
Clause 107. The method of any clause or example herein, in particular, any one of Clauses 93-106, further comprising, after the providing and prior to the compressing, disposing additional lignin on one, some, or all of the plurality of pieces of plant material.
Clause 108. The method of any clause or example herein, in particular, Clause 107, wherein the additional lignin comprises kraft lignin.
Clause 109. An engineered structure formed by the method of any clause or example herein, in particular, any one of Clauses 46-108.

### CONCLUSION

Any of the features illustrated or described herein, for example, with respect to FIGS. 1A-14B and Clauses 1-109, can be combined with any other feature illustrated or described herein, for example, with respect to FIGS. 1A-14B and Clauses 1-109 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. An engineered structure comprising:
a plurality of pieces of plant material arranged to form at least two layers, at least some of the pieces being lignin-compromised plant material; and
a filler or bonding agent coupling together adjacent pieces of the plant material so as to form a unitary layered structure,
wherein the filler comprises a polysaccharide or the bonding agent comprises lignin.

2-4. (canceled)

5. The engineered structure of claim 1, wherein the polysaccharide is starch, chitin, chitosan, cellulose, carboxymethyl cellulose, methyl cellulose, ethyl hydroxyethyl cellulose, hydroxyethyl cellulose, or hydroxypropyl methylcellulose.

6-17. (canceled)

18. The engineered structure of claim 1, wherein the filler fills gaps between and within adjacent one of the pieces of plant material, and/or the filler provides additional bonding points for hydrogen bond formation with cellulose fibers.

19-22. (canceled)

23. The engineered structure of claim 1, wherein the lignin-compromised plant material comprises at least partially delignified plant material.

24-26. (canceled)

27. The engineered structure of claim 1, wherein the lignin-compromised plant material comprises modified lignin therein, and the modified lignin has shorter macromolecular chains than that of native lignin in corresponding natural plant material.

28-29. (canceled)

30. The engineered structure of claim 27, wherein one, some, or all of the pieces of lignin-compromised plant material comprises a salt immobilized within a cellulose-based microstructure of the lignin-compromised plant material.

31-37. (canceled)

38. The engineered structure of claim 1, wherein:
the lignin-compromised plant material has modified lignin, the modified lignin having more exposed functional groups on its surface as compared to native lignin of corresponding natural plant material, and the bonding agent comprises at least some of the modified lignin from the lignin-compromised plant material; and
the at least some of the modified lignin is physically entangled with and bonded to cellulose nanofibrils of the adjacent pieces of the plant material.

39-41. (canceled)

42. The engineered structure of claim 38, wherein a lignin content in the unitary layered structure is in a range of 15-20 wt %, inclusive.

43-45. (canceled)

46. A method comprising:
providing a plurality of pieces of plant material, at least some of the pieces being lignin-compromised plant material;
after the providing, disposing a filler on one, some, or all of the plurality of pieces of plant material;
arranging the plurality of pieces of plant material in at least two layers; and
compressing the at least two layers so as to form a unitary layered structure,
wherein the filler comprises a polysaccharide, and
after the compressing, the filler fills gaps between and within adjacent one of the pieces of plant material, and/or the filler provides additional bonding points for hydrogen bond formation with cellulose fibers.

47. (canceled)

48. The method of claim 46, wherein the disposing the filler is performed between arranging of separate layers of the at least two layers.

49. The method of claim 46, wherein during the disposing and/or the arranging, at least some of the pieces of plant material have a water content in a range of 15-35 wt %.

50-56. (canceled)

57. The method of claim 46, wherein:
the polysaccharide has a plurality of polar functional groups that originate from an organic acid;
the plurality of polar functional groups comprises carboxyl groups, hydroxyl groups, or both carboxyl and hydroxyl groups;
the polysaccharide comprises a polysaccharide of anhydroglucose or a derivative thereof;
the polysaccharide comprises starch, chitin, chitosan, cellulose, carboxymethyl cellulose, methyl cellulose, ethyl hydroxyethyl cellulose, hydroxyethyl cellulose, or hydroxypropyl methylcellulose;
the polysaccharide comprises sodium alginate, xanthan gum, guar gum, carrageenan, or gum arabic; or
any combination of the above.

58. The method of claim 46, wherein the polysaccharide comprises carboxymethyl cellulose.

59. The method of claim 46, wherein a content of the filler in the unitary layered structure after the compressing is in a range of 1-5 wt %.

60-66. (canceled)

67. The method of claim 46, wherein:
the providing comprises subjecting pieces of natural plant material having native lignin therein to one or more chemical treatments so as to compromise the native lignin, thereby forming the pieces of lignin-compromised plant material; and
after the subjecting, the pieces of lignin-compromised plant material have modified lignin therein, and the modified lignin has shorter macromolecular chains than that of native lignin in the pieces of natural plant material.

68-74. (canceled)

75. The method of claim 67, wherein:
the subjecting comprises:
infusing the pieces of natural plant material with one or more chemical solutions; and
after the infusing, exposing the pieces of natural plant material with the one or more chemical solutions therein to a first temperature of at least 100° C. for a first time, so as to form the pieces of lignin-compromised plant material;
after the subjecting to the first temperature for the first time, a salt is immobilized within a cellulose-based microstructure of the pieces of lignin-compromised plant material, and
the salt is formed by reaction of the one or more chemical solutions with an acidic degradation product of native hemicellulose in the pieces of natural plant material produced by the one or more chemical solutions.

76-77. (canceled)

78. The method of claim 46, wherein:
the providing comprises subjecting pieces of natural plant material having native lignin therein to one or more chemical treatments so as to compromise the native lignin, thereby forming the pieces of lignin-compromised plant material, and
after the subjecting to a chemical treatment, the pieces of lignin-compromised plant material is at least partially delignified.

79-92. (canceled)

93. A method comprising:
providing a plurality of pieces of plant material, at least some of the pieces being lignin-compromised plant material;
arranging the plurality of pieces of plant material in at least two layers; and
compressing the at least two layers so as to form a unitary layered structure,
wherein:
the lignin-compromised plant material has modified lignin with more exposed functional groups on its surface as compared to native lignin of corresponding natural plant material,
the compressing is such that the at least some of the modified lignin from the lignin-compromised plant material acts as a bonding agent to couple together adjacent pieces of the plant material in the unitary layered structure, and
after the compressing, the at least some of the modified lignin is physically entangled with and bonded to cellulose nanofibrils of the adjacent pieces of the plant material.

94-104. (canceled)

105. The method of claim 93, wherein the compressing is performed at a temperature greater than a glass transition temperature of the modified lignin.

106. (canceled)

107. The method of claim 93, further comprising, after the providing and prior to the compressing, disposing additional lignin on one, some, or all of the plurality of pieces of plant material.

108. (canceled)
